(19) United States
(12) Patent Application Publication
(10) Pub. No.: US 2008/0159188 A1
(43) Pub. Date: Jul. 3, 2008

(54) Serial interface apparatus performing asynchronous serial data transfer using asynchronous serial communication method

(76) Inventor: Kenichi Funagai, Kanagawa (JP)

Correspondence Address: WENDEROTH, LIND & PONACK L.L.P., 2033 K. STREET, NW, SUITE 800, WASHINGTON, DC, 20006, US

(21) Appl. No.: 11/819,665

(22) Filed: Jun. 28, 2007

(30) Foreign Application Priority Data
Jun. 28, 2006 (JP) 2006-178044

(51) Int. Cl. H04L 5/22

(52) U.S. Cl. 370/298

(57) ABSTRACT

A serial interface apparatus includes a first signal terminal sharing a data transmitting terminal and a second control signal terminal, a second signal terminal sharing a data receiving terminal and a first control signal terminal, and first to fourth buffer amplifiers. Upon receiving two types of second control signals different from each other from the other side apparatuses after transmitting the first control signal to the other side apparatus, the controller executes half-duplex data communication using the two signal terminals by transmitting the serial data signal to the other side apparatus via the first signal terminal, transmitting to the first signal terminal a serial data signal indicating a notice of termination upon end of the serial data signal to be transmitted, and judging as a data communication termination upon reception of the second control signal from the other side apparatus in response to the transmission of the serial data signal.

### FIELD OF THE INVENTION

The present invention relates to a serial interface apparatus that bidirectionally performs asynchronous serial data transfer using an asynchronous serial communication method such as Universal Asynchronous Receiver-Transmitter (referred to as UART hereinafter), a bidirectional serial interface system using the serial interface apparatus, and a serial communication method for use in the serial interface apparatus.

### DESCRIPTION OF THE RELATED ART

In recent years, portable information apparatuses are required for user convenience by connecting to a plurality of external apparatuses in response to various application functions. Currently, serial data communication generally using UART has been widely used.

First of all, a bidirectional serial interface system consisted of a master unit 300 and a slave unit 400 using a UART interface according to the prior art disclosed in Japanese Patent Laid-open Publication No. 2003-5874 and Japanese Patent Laid-open Publication No. 11-127219 will be described below with reference to FIGS. 16 to 18. FIG. 16 is a block diagram showing a configuration of the bidirectional serial interface system. FIG. 17 is a timing chart showing a signal format of each signal for use in the bidirectional serial interface system shown in FIG. 16. Further, FIG. 18 is a sequence diagram showing a signal transmitting and receiving procedure executed in the bidirectional serial interface system shown in FIG. 17. In this case, the master unit 300 is a portable information terminal apparatus, for example. The slave unit 400 is an external apparatus such as a PDA (Personal Digital Assistants) connected to the portable information terminal apparatus, for example.

Referring to FIG. 16, the master unit 300 includes a CPU 301 for executing data transfer, a UART interface 302 for executing interface processing on signals for data transfer, and signal terminals 303 to 306. The signal terminals 303 to 306 include the following four signal terminals:

(a) a signal terminal (referred to as a TXD terminal hereinafter) 303 for transmitting a transmission data signal (referred to as a TXD signal hereinafter) to the slave unit 400;

(b) a signal terminal (referred to as an RXD terminal hereinafter) 304 for receiving a received data signal (referred to as an RXD signal hereinafter) from the slave unit 400;

(c) a signal terminal (referred to as an RTS terminal hereinafter) 305 for transmitting a Return To Send signal (referred to as an RTS signal hereinafter) for confirmation of transmission request to the slave unit 400; and

(d) a signal terminal (referred to as a CTS terminal hereinafter) 306 for receiving a Clear To Send signal (referred to as a CTS signal hereinafter) indicating confirmation of possibly receiving from the slave unit 400.

In this case, the UART interface 302 incorporates a parallel to serial converter (referred to as a P/S converter hereinafter) for performing parallel to serial conversion of a parallel data signal to be transmitted from the CPU 301 into a serial data signal, and a serial to parallel converter (referred to as an S/P converter hereinafter) for performing serial to parallel conversion of the received serial data signal into a parallel data signal to output the parallel data signal to the CPU 301.

Meanwhile, the slave unit 400 includes a CPU 401 for executing data transfer, a UART interface 402 for executing interface processing on signals for the data transfer, and signal terminals 403 to 406. The signal terminals 403 to 406 include the following four signal terminals:

(a) a signal terminal (referred to as a TXD terminal hereinafter) 403 for transmitting a TXD signal to the master unit 300;

(b) a signal terminal (referred to as an RXD terminal hereinafter) 404 for receiving an RXD signal from the master unit 300;

(c) a signal terminal (referred to as an RTS terminal hereinafter) 405 for transmitting an RTS signal to the master unit 300; and

(d) a signal terminal (referred to as a CTS terminal hereinafter) 406 for receiving a CTS signal from the master unit 300.

In this case, the UART interface 402 incorporates a P/S converter for performing parallel to serial conversion of a parallel data signal to be transmitted from the CPU 401 into a serial data signal, and an S/P converter for performing serial to parallel conversion of the received serial data signal into a parallel data signal to output the parallel data signal to the CPU 401.

After that, an operation of the data communication of the bidirectional serial interface system shown in FIG. 16 will be described below with reference to a signal timing chart shown in FIG. 17 and a sequence diagram shown in FIG. 18. Referring to FIGS. 17 and 18, respective signals are fixed to be a H level in an initial state. By changing of an RTS signal transmitted by the master unit 300 from the H level to a L level and transmitting a trailing edge signal of the RTS signal, the master unit 300 transmits the RTS signal having the L level (trailing edge signal of the RTS signal) indicating “confirmation of transmission request” for the slave unit 400, then waits for transmitting authorization of the slave unit 400. The slave unit 400 receives the trailing edge signal of the RTS signal as a trailing edge signal of the CTS signal. In response to the trailing edge signal of the RTS signal, with changing of the RTS signal transmitted by the slave unit 400 from the H level to the L level, the slave unit 400 transmits the trailing edge signal of the RTS signal. Then, the slave unit 400 transmits the RTS signal having the L level indicating “possibly receiving of data” to the master unit 300 to set a state of receiving start-up. Thereafter, after the completion of receiving start-up of the slave unit 400, the master unit 300 detects the trailing edge signal of the CTS signal transmitted from the slave unit 400 to start the data transmission. That is, the master unit 300 executes the data transmission by transmitting a TXD signal including the transmission data to the slave unit 400. In response to the TXD signal, the slave unit 400 receives the TXD signal from the master unit 300 as an RXD signal. After completion of receiving the TXD signal, the slave unit 400 transmits a leading edge signal of the RTS signal indicating confirmation of completion of receiving to the master unit 300. The master unit 300 receives the leading edge signal of the CTS signal as a leading edge signal of the CTS signal. That is, when the master unit 300 judges as completion of transmission after detecting the leading edge signal of the RTS signal from the slave unit 400, the master unit 300 transmits the leading edge signal of the RTS signal to the slave unit 400, and then, the slave unit 400 receives the leading edge signal of the RTS signal as the leading edge signal of the CTS signal. That is, when the slave unit 400 detects the leading edge signal of the CTS signal from the master unit 300, completion of the data communication is made.

As shown in FIG. 17, the transmission data transmitted by the TXD signal constitutes 1 data frame formed such that a data bit 503 of 8 bits and a parity bit 504 of 1 bit are sandwiched between a start bit 501 of 1 bit and a stop bit 502 of 2 bits. The bit width of the data frame is variable. In addition, transmitting and receiving timing detection, transmitting error detection, receiving error detection, and the like, are performed by confirming and detecting a pattern of the three data excluding the data bit 503 and the leading edge signal or trailing edge signal.

The data transfer method described above is called as a full-duplex communication method. Whereas, a transfer method in which the data transfer of the TXD signal and the RXD signal is performed via one terminal (the data transfer by time division change-over of transmitting and receiving) is called as a half-duplex communication method. In the UART, the full-duplex communication method is generically accepted in view of advantages such as data size, transfer rate or the like.

In recent years, portable information apparatuses have been required for versatility also in interface circuits because there have been wide variety of external apparatuses to be connected. In the bidirectional serial interface system related to the prior art, for example, using the UART interface, application functions of personal digital assistance are increased and interfacing to external apparatuses is added in order to correspond to versatility. However, in the data communication apparatuses with the bidirectional serial interface system related to the prior art, since a port for every four terminals has to be provided on the LSI side every time the function is added, and as a result, chip area of the LSI increases, resulting in cost-up of hardware and drawbacks in reducing the number of components and the size.

### SUMMARY OF THE INVENTION

An object of the present invention is to solve the foregoing problem and to provide a serial interface apparatus capable of performing bidirectional serial data communication with less number of signal terminals as compared with the prior art, a bidirectional serial interface system using the serial interface apparatus, and a serial communication method for the above-mentioned serial interface apparatus.

According to the first aspect of the present invention, there is provided a serial interface apparatus including a controller, a parallel to serial converter, a data transmitting terminal, a data receiving terminal, a serial to parallel converter, a first control signal terminal and a second control signal terminal. The controller generates a parallel data signal and a control signal, and performs communication control. The parallel to serial converter converts a parallel data signal to be transmitted from the controller, into a serial data signal. The data transmitting terminal transmits the converted serial data signal to other side apparatus. The data receiving terminal receives the serial data signal from the other side apparatus. The serial to parallel converter converts the received serial data signal into a parallel data signal, and outputs the parallel data signal to the controller. The first control signal terminal transmits a first control signal for confirmation of transmission request from the controller to the other side apparatus. The second control signal terminal receives a second control signal indicating confirmation of possibly receiving from the other side apparatus, and outputs the received second control signal to the controller. The serial interface apparatus further includes a first signal terminal, a second signal terminal, a first buffer amplifier, a second buffer amplifier, a third buffer amplifier and a fourth buffer amplifier. The first signal terminal shares the data transmitting terminal and the second control signal terminal. The second signal terminal shares the data receiving terminal and the first control signal terminal. The first buffer amplifier buffer-amplifies the converted serial data signal, and outputs a buffer-amplified serial data signal to the first signal terminal. The second buffer amplifier buffer-amplifies the serial data signal received via the second signal terminal, and outputs a buffer-amplified serial data signal to the serial to parallel converter. The third buffer amplifier buffer-amplifies the first control signal, and outputs a buffer-amplified first control signal to the second signal terminal. The fourth buffer amplifier buffer-amplifies the received second control signal via the first signal terminal, and outputs a buffer-amplified second control signal to the controller. In the serial interface apparatus, upon receiving two types of second control signals different from each other from the other side apparatuses after transmitting the first control signal to the other side apparatus, the controller executes half-duplex data communication using the two signal terminals by transmitting the serial data signal to the other side apparatus via the first signal terminal, transmitting to the first signal terminal a serial data signal indicating a notice of termination upon end of the serial data signal to be transmitted, and judging as a data communication termination upon reception of the second control signal from the other side apparatus in response to the transmission of the serial data signal.

The above serial interface apparatus further includes a first level adjusting circuit and a second level adjusting circuit. The first level adjusting circuit, disposed between the first signal terminal and the fourth buffer amplifier, adjusts a level of the second control signal received via the first signal terminal to be a predetermined level. The second level adjusting circuit, disposed between the second signal terminal and the second buffer amplifier, adjusts a level of the serial data signal received via the second signal terminal to be a predetermined level.

In addition, the above serial interface apparatus further includes a further parallel to serial converter, a further serial to parallel converter, a first selector and a second selector. The further parallel to serial converter converts the parallel data signal to be transmitted from the a controller, into a serial data signal. The further serial to parallel converter converts the received serial data signal into a parallel data signal, and outputs the parallel data signal to the controller. The first selector selects the first control signal from the controller and outputs the selected first control signal to the third buffer amplifier in a first operation mode, and selects the serial data signal from the further parallel to serial converter and outputs the selected serial data signal to the third buffer amplifier in a second operation mode. The second selector selects the second control signal received via the second buffer amplifier and outputs the selected second control signal to the controller in the first operation mode, and selects the serial data signal received via the second buffer amplifier and outputs the selected serial data signal to the further serial to parallel converter in the second operation mode. In the above serial interface apparatus, in the first operation mode, upon receiving two types of second control signals different from each other from the other side apparatuses after transmitting the first control signal to the other side apparatus, the controller executes full-duplex data communication using the two signal terminals by being set from the first operation mode to the second operation mode, transmitting the serial data signal to the further side apparatus via the first signal terminal, receiving the serial data signal from the further side apparatus via the second signal terminal, transmitting to the first signal terminal a serial data signal indicating a notice of termination upon end of the serial data signal to be transmitted, and judging as a data communication termination upon reception of the second control signal from the further side apparatus in response to the transmission of the serial data signal.

According to the second aspect of the present invention, there is provided a bidirectional serial interface system including first and second serial interface apparatuses, each of which is the above-mentioned serial interface apparatus. In the bidirectional serial interface system, the first and second serial interface apparatuses being connected and disposed so as to oppose to each other.

According to the third aspect of the present invention, there is provided a serial communication method for use in a serial interface apparatus. The serial interface apparatus includes a first signal terminal and a second signal terminal. The first signal terminal shares a data transmitting terminal for transmitting a converted serial data signal to other side apparatus which is a serial interface apparatus, and a second control signal terminal for receiving a second control signal indicating confirmation of possibly receiving from the other side apparatus and outputting the received second control signal to a controller. The second signal terminal shares a data receiving terminal for receiving the serial data signal from the other side apparatus, and a first control signal terminal for transmitting a first control signal for confirmation of transmission request from the controller to the other side apparatus. The serial communication method includes the following steps of transmitting the first control signal to the other side apparatus, transmitting the serial data signal to the other side apparatus via the first signal terminal upon receiving two types of second control signals different from each other from the other side apparatuses, and transmitting to the first signal terminal a serial data signal indicating a notice of termination upon end of the serial data signal to be transmitted, and judging as a data communication termination upon reception of the second control signal from the other side apparatus responded to the transmission of the serial data signal, thereby executing half-duplex data communication using the two signal terminals.

The above serial communication method further includes transmitting the first control signal to the other side apparatus, transmitting the serial data signal to the other side apparatus via the first signal terminal upon receiving two types of second control signals different from each other from the other side apparatuses, receiving the serial data signal from the other side apparatus via the second signal terminal, and transmitting to the first signal terminal a serial data signal indicating a notice of termination upon end of the serial data signal to be transmitted, and judging as a data communication termination receiving the second control signal from the other side apparatus responded to the transmission of the serial data signal, thereby executing full-duplex data communication using the two signal terminals.

Therefore, according to a serial interface apparatus, a bidirectional serial interface system using the same serial interface apparatus, and a serial communication method for the serial interface apparatus according to the present invention, by providing the above-mentioned configuration, half-duplex or full-duplex, bidirectional, asynchronous serial data communication equivalent to the UART interface related to the prior art can be realized by using two signal terminals which are less in number than the prior art, and this leads to that cost of hardware of each apparatus can be largely reduced. Furthermore, providing the above-mentioned first and second level adjusting circuits allows the data communication by adjusting output voltage even when source voltage is different from that of other side apparatuses.

### BRIEF DESCRIPTION OF THE DRAWINGS

These and other objects and features of the present invention will become clear from the following description taken in conjunction with the preferred embodiments thereof with reference to the accompanying drawings throughout which like parts are designated by like reference numerals, and in which:

FIG. 1 is a block diagram showing a configuration of a bidirectional serial interface system composed of a master unit 100 and a slave unit 200 according to a first preferred embodiment of the present invention;

FIG. 2 is a flow chart showing a first part of data transmission processing executed by the master unit 100 shown in FIG. 1, and a first part of a data receiving process executed by the slave unit 200 shown in FIG. 1;

FIG. 3 is a flow chart showing a second part of the data transmission processing executed by the master unit 100 shown in FIG. 1, and a second part of the data receiving process executed by the slave unit 200 shown in FIG. 1;

FIG. 4 is a flow chart showing a third part of the data transmission processing executed by the master unit 100 shown in FIG. 1, and a third part of the data receiving process executed by the slave unit 200 shown in FIG. 1;

FIG. 5 is a sequence diagram showing a signal transmitting and receiving procedure executed in the/a bidirectional serial interface system according to the first and a second preferred embodiments;

FIG. 6 is a block diagram showing a configuration of the bidirectional serial interface system composed of a master unit 100A and a slave unit 200A according to the second preferred embodiment of the present invention;

FIG. 7 is a flow chart showing a first part of data transmission processing executed by the master unit 100A shown in FIG. 6, and a first part of a data receiving process executed by the slave unit 200A shown in FIG. 6;

FIG. 8 is a flow chart showing a second part of the data transmission processing executed by the master unit 100A shown in FIG. 6, and a second part of the data receiving process executed by the slave unit 200A shown in FIG. 6;

FIG. 9 is a flow chart showing a third part of the data transmission processing executed by the master unit 100A shown in FIG. 6, and a third part of the data receiving process executed by the slave unit 200A shown in FIG. 6;

FIG. 10 is a block diagram showing a configuration of a bidirectional serial interface system composed of a master unit 100B and a slave unit 200B according to a third preferred embodiment of the present invention;

FIG. 11 is a flow chart showing a first part of a data transmission and receiving process executed by the master unit 100B shown in FIG. 10, and a first part of a data transmission and receiving process executed by the slave unit 200B shown in FIG. 10;

FIG. 12 is a flow chart showing a second part of the data transmission and receiving process executed by the master unit 100B shown in FIG. 10, and a second part of the data transmission and receiving process executed by the slave unit 200B shown in FIG. 10;

FIG. 13 is a flow chart showing a third part of the data transmission and receiving process executed by the master unit 100B shown in FIG. 10, and a third part of the data transmission and receiving process executed by the slave unit 200B shown in FIG. 10;

FIG. 14 is a flow chart showing a fourth part of the data transmission and receiving process executed by the master unit 100B shown in FIG. 10, and a fourth part of the data transmission and receiving process executed by the slave unit 200B shown in FIG. 10;

FIG. 15 is a sequence diagram showing a signal transmitting and receiving procedure executed in the bidirectional serial interface system according to the third preferred embodiment;

FIG. 16 is a block diagram showing a configuration of a bidirectional serial interface system composed of a master unit 300 and a slave unit 400 related to the prior art;

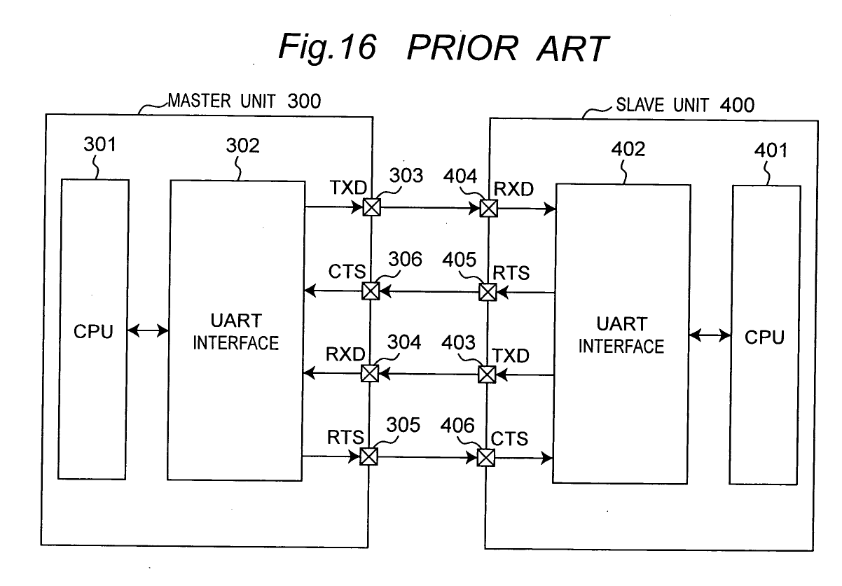

FIG. 17 is a timing chart showing a signal format of each signal for use in the bidirectional serial interface system shown in FIG. 16; and

FIG. 18 is a sequence diagram showing a signal transmitting and receiving procedure executed in the bidirectional serial interface system shown in FIG. 17.

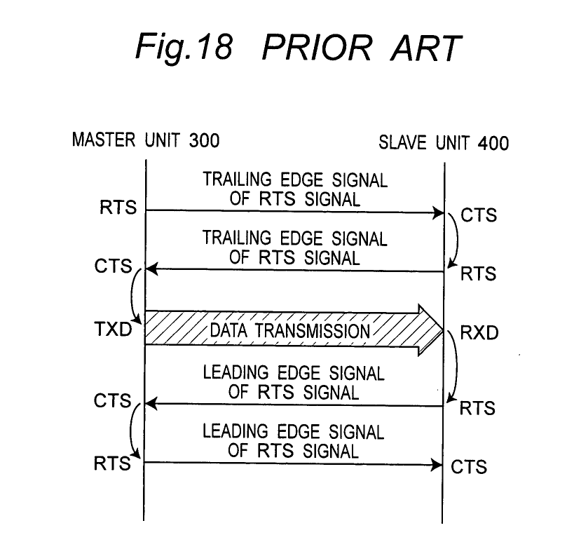

### DETAILED DESCRIPTION OF THE PREFERRED EMBODIMENTS

The preferred embodiments according to the present invention will be described below with reference to the attached drawings. In addition, the same reference numerals are given to those similar to constituent elements shown in each of the following preferred embodiments.

### First Preferred Embodiment

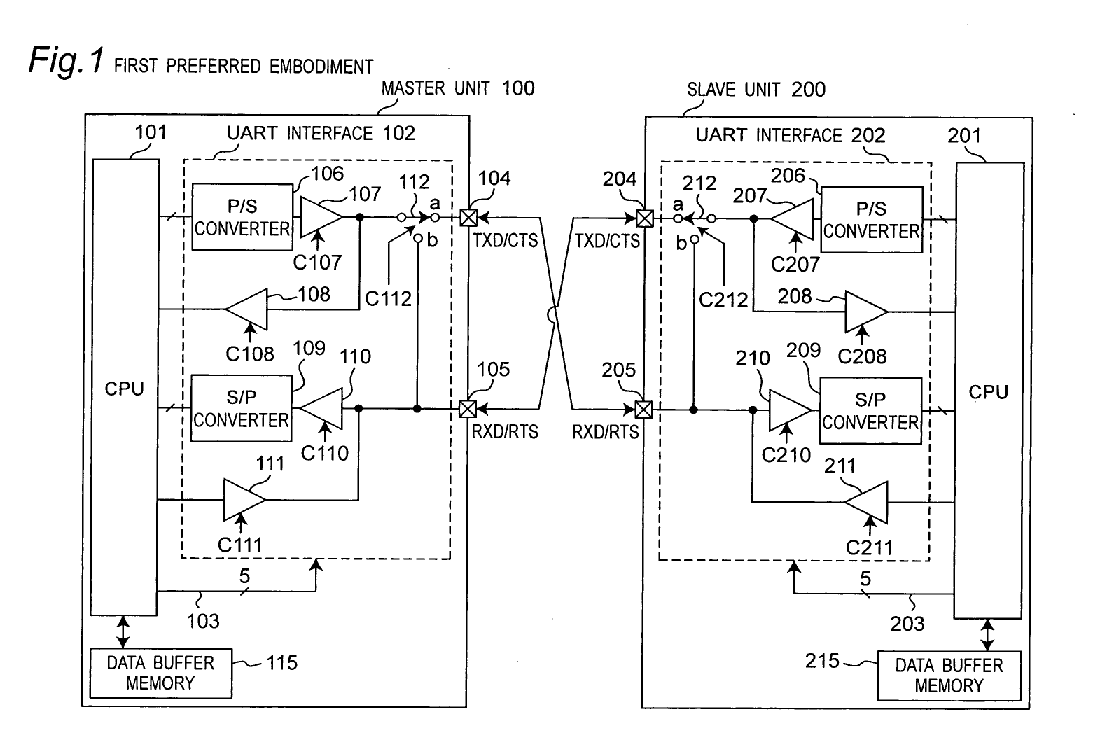

FIG. 1 is a block diagram showing a configuration of a bidirectional serial interface system composed of a master unit 100 and a slave unit 200 according to a first preferred embodiment of the present invention. As shown in FIG. 1, it is characterized in that the bidirectional serial interface system according to the first preferred embodiment is composed of the master unit 100 which is, for example, a portable information terminal apparatus or a personal computer or the line, and the slave unit 200 which is an external apparatus such as a PDA or a communication terminal apparatus. The master unit 100 has respectively shared two signal terminals 104 and 105. The slave unit 200 has respectively shared two signal terminals 204 and 205.

That is, the master unit 100 has following terminals:

(a) a signal terminal (referred to as a TXD/CTS terminal hereinafter) 104 shared by a TXD signal terminal and a CTS signal terminal; and

(b) a signal terminal (referred to as an RXD/RTS terminal hereinafter) 105 shared by an RXD signal terminal and an RTS signal terminal.

In addition, the slave unit 200 has following terminals:

(a) a TXD/CTS terminal 204 shared by a TXD signal terminal and a CTS signal terminal; and

(b) an RXD/RTS terminal 205 shared by an RXD signal terminal and an RTS signal terminal.

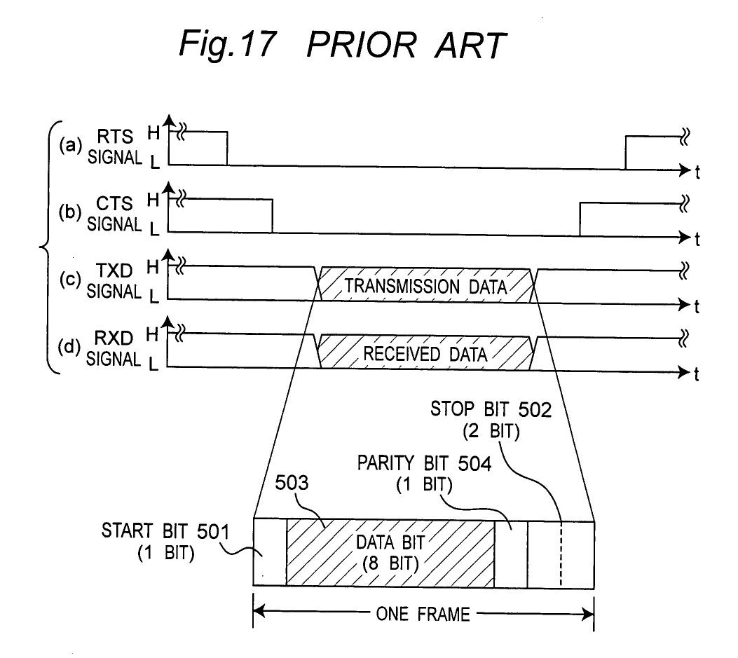

In this case, the TXD/CTS terminal 104 of the master unit 100 is connected to the RXD/RTS terminal 205 of the slave unit 200. The RXD/RTS terminal 105 of the master unit 200 is connected to the TXD/CTS terminal 204 of the slave unit 200. That is, the master unit 100 and the slave unit 200 are connected by a cross connection so as to be opposed to each other. In addition, data and each signal transmitted between the master unit 100 and the slave unit 200 have a signal format shown in FIG. 17, as in the prior art, for example.

Referring to FIG. 1, the master unit 100 includes a CPU 101 which is a controller for executing the data communication, a data buffer memory 115 connected to the CPU 101, for storing digital data to be transmitted and received for retransmitting especially when a communication error occurs, a UART interface 102 connected to the CPU 101, for executing interface processing of the data communication with the slave unit 200, a control line 103 for transmitting control signals C107, C108, C110, C111 and C112 for controlling each part of the UART interface 102 by the CPU 101, and the two shared signal terminals 104 and 105. Meanwhile, the slave unit 200 has a configuration similar to the master unit 100, that is, the slave unit 200 includes a CPU 201 which is a controller for executing the data communication, a data buffer memory 215 connected to the CPU 201, for storing digital data to be transmitted and received, a UART interface 202 connected to the CPU 201, for executing interface processing of the data communication with the master unit 100, a control line 203 for transmitting control signals C207, C208, C210, C211 and C212 for controlling each part of the UART interface 202 by the CPU 201, and the two shared signal terminals 204 and 205.

Referring to FIG. 1, the UART interface 102 of the master unit 100 includes a P/S converter 106, a buffer amplifier 107 whose ON/OFF of operation is switched over by the control signal C107, a buffer amplifier 108 whose ON/OFF of operation is switched over by the control signal C108, an S/P converter 109, a buffer amplifier 110 whose ON/OFF of operation is switched over by the control signal C110, a buffer amplifier 111 whose ON/OFF of operation is switched over by the control signal C111, and a switch 112 for use in a loopback test of the self-apparatus. In this case, the switch 112 is switched over to the contact “a” side during the data communication, and the switch 112 is switched over to the contact “b” side during the loopback test of the self-apparatus. In addition, the buffer amplifiers 107, 108, 110 and 111 are those which buffer-amplify and output inputted data signals, and the other buffer amplifiers to be described later also operate similarly.

In the UART interface 102, parallel transmission data transmitted from the CPU 101 is parallel-to-serial-converted into serial transmission data by the P/S converter 106, which is then outputted to the TXD/CTS terminal 104 as a TXD signal via the buffer amplifier 107 and the contact “a” side of the switch 112. Meanwhile, the CTS signal inputted via the TXD/CTS terminal 104 is outputted to the CPU 101 via the contact “a” side of the switch 112 and the buffer amplifier 108. Furthermore, the RXD signal including serial received data inputted via the RXD/RTS terminal 105 are inputted to the S/P converter 109 via the buffer amplifier 110, and are parallel-to-serial-converted into serial received data by the S/P converter 109, which are then outputted to the CPU 101. Meanwhile, an RTS signal transmitted from the CPU 101 is outputted to the RXD/RTS terminal 105 via the buffer amplifier 111.

Referring to FIG. 1, the UART interface 202 of the slave unit 200 includes a P/S converter 206, a buffer amplifier 207 whose ON/OFF of operation is switched over by the control signal C207, a buffer amplifier 208 whose ON/OFF of operation is switched over by the control signal C208, an S/P converter 209, a buffer amplifier 210 whose ON/OFF of operation is switched over by the control signal C210, a buffer amplifier 211 whose ON/OFF of operation is switched over by the control signal C211, and a switch 212 for use in a loopback test of the self-apparatus. In this case, the switch 212 is switched over to the contact “a” side during the data communication, and the switch 212 is switched over to the contact “b” side during the loopback test of the self-apparatus.

In the UART interface 202, the parallel transmission data transmitted from the CPU 201 is parallel-to-serial-converted into the serial transmission data by the P/S converter 206, which is then outputted to the TXD/CTS terminal 204 as a TXD signal via the buffer amplifier 207 and the contact “a” side of the switch 212. Meanwhile, the CTS signal inputted via the TXD/CTS terminal 204 is outputted to a CPU 208 via the contact “a” side of the switch 212 and the buffer amplifier 208. Furthermore, the RXD signal including serial received data inputted via the RXD/RTS terminal 205 is inputted to the S/P converter 209 via the buffer amplifier 210, and is parallel-to-serial-converted into serial received data by the S/P converter 209, which is then outputted to the CPU 201. Meanwhile, an RTS signal transmitted from the CPU 201 is outputted to the RXD/RTS terminal 205 via the buffer amplifier 211.

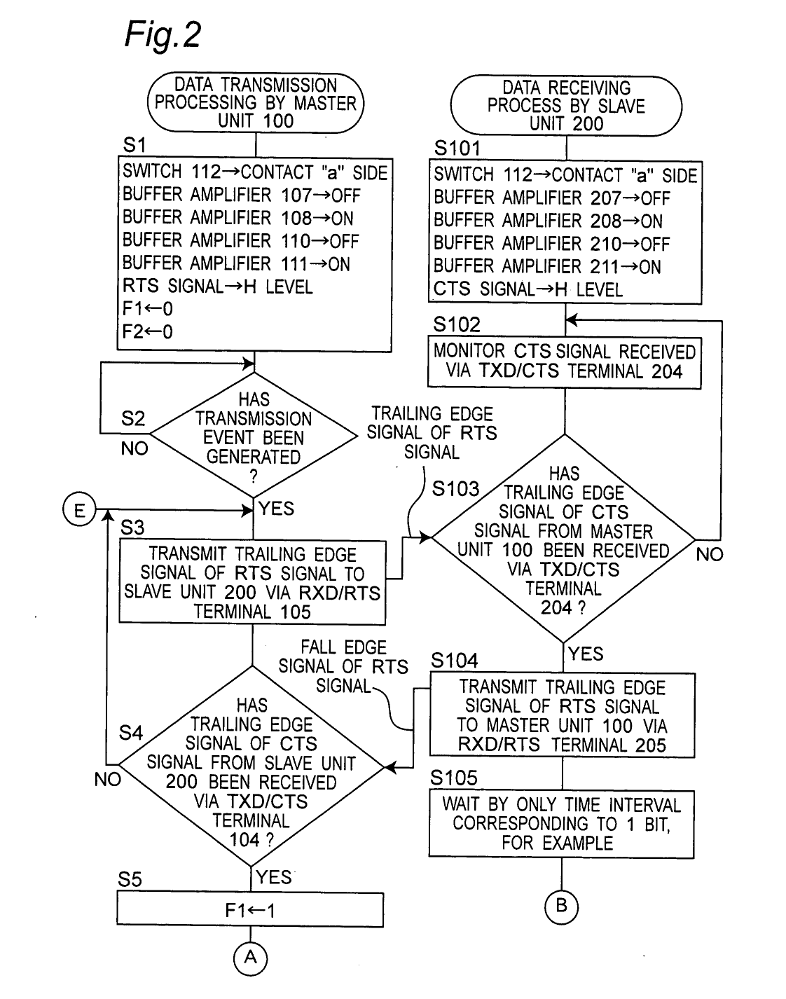

The data communication processing of the bidirectional serial interface system configured as described above will be described below with reference to FIGS. 2 to 4. FIGS. 2 to 4 are flow charts showing data transmission processing executed by the master unit 100 shown in FIG. 1 and a data receiving process executed by the slave unit 200 shown in FIG. 1.

First of all, the data transmission processing executed by the master unit 100 shown in FIG. 1 will be described below with reference to FIGS. 2 to 4.

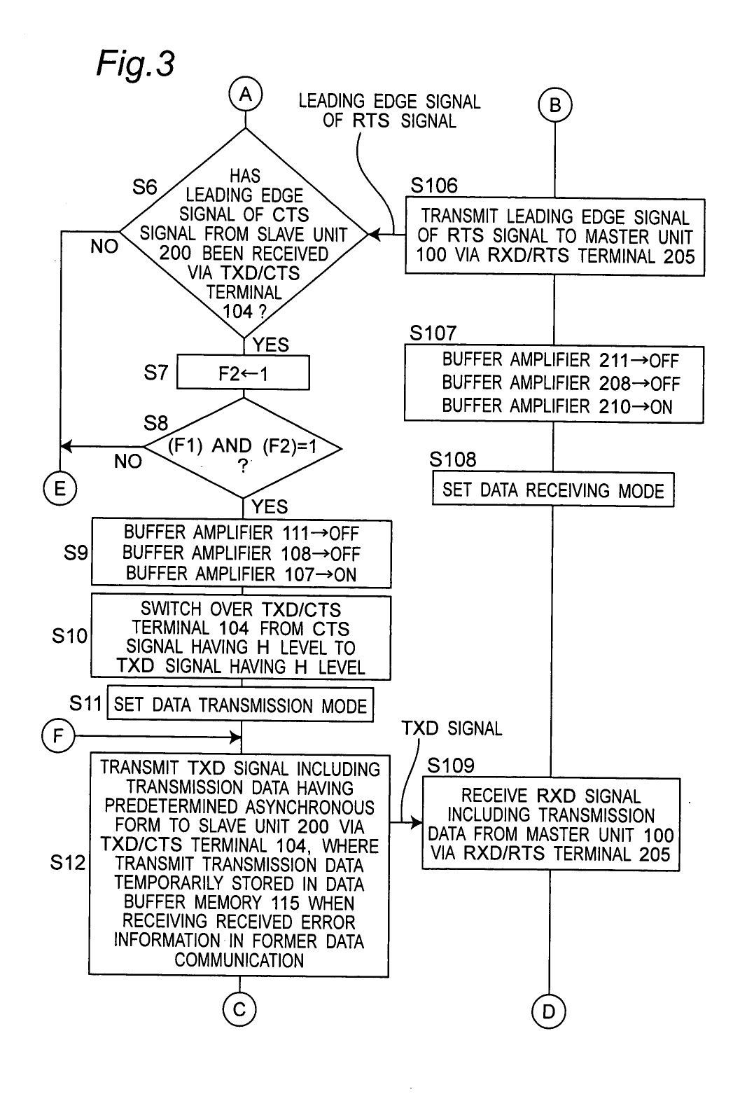

At step S1 of FIG. 2, an initial setting process is executed as follows. That is, the switch 112 is switched over to the contact “a” side, the buffer amplifier 107 is turned OFF, the buffer amplifier 108 is turned ON, the buffer amplifier 110 is turned OFF, and the buffer amplifier 111 is turned ON. Furthermore, the RTS signal is set to the H level, a receiving flag F1 indicating that a trailing edge signal of the CTS signal has been received, is reset to 0, and a receiving flag F2 is reset to 0. After that, at step S2, it is judged whether or not a transmission event has been generated, and processing of step S2 is repeated till a YES judgment is made. If YES at step S2, a trailing edge signal of the RTS signal is transmitted to the slave unit 200 via the RXD/RTS terminal 105 at step S3. At step S4, it is judged whether or not the trailing edge signal of the CTS signal from the slave unit 200 has been received via the TXD/CTS terminal 104. If YES at step S4, the control flow proceeds to step S5. On the other hand, if NO at step S4, the control flow returns to step S3. At step S5, the receiving flag F1 is set to 1, and then, the control flow proceeds to step S6 of FIG. 3.

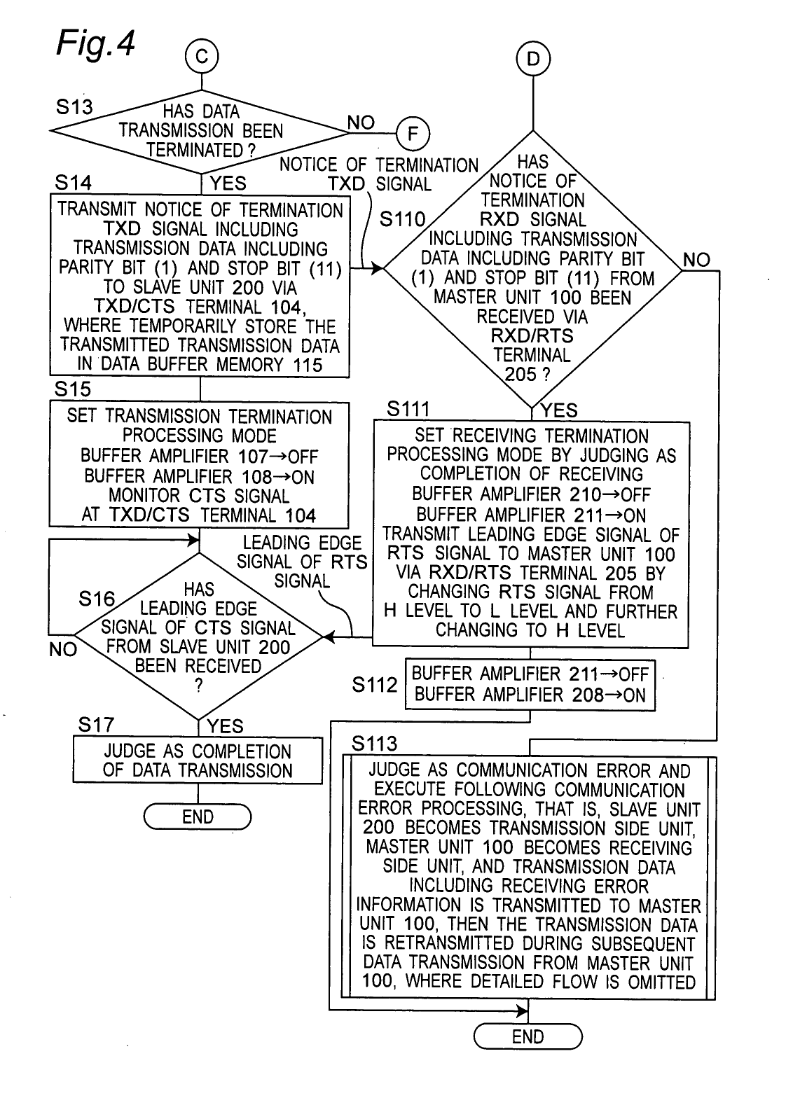

At step S6 of FIG. 3, it is judged whether or not a leading edge signal of the CTS signal from the slave unit 200 has been received via the TXD/CTS terminal 104. If YES at step S6, the control flow proceeds to step S7. On the other hand, if NO at step S6, the control flow returns to step S3. At step S7, the receiving flag F2 indicating that the leading edge signal of the CTS signal has been received, is set to 1. At step S8, it is judged whether or not logical AND of the receiving flag (F1) and the receiving flag (F2) is 1. If YES at step S8, the control flow proceeds to step S9. On the other hand, if NO at step S8, the control flow returns to step S3. At step S9, the buffer amplifier 111 is turned OFF, the buffer amplifier 108 is turned OFF, and the buffer amplifier 107 is turned ON. Then, at step S10, the TXD/CTS terminal 104 is switched over from a CTS signal having the H level to a TXD signal having the H level. At step S11, a data transmission mode is set. Further, at step S12, a TXD signal including the transmission data having a predetermined asynchronous form is transmitted to the slave unit 200 via the TXD/CTS terminal 104. It is noted that the transmission data temporarily stored in the data buffer memory 115 is transmitted when reception error information is received in the former data communication. Then, the control flow proceeds to step S13 shown in FIG. 4.

At step S13 of FIG. 4, it is judged whether or not the data transmission has been terminated. If YES at step S13, the control flow proceeds to step S14. On the other hand, if NO at step S13, the control flow returns to step S12. At step S14, a notice of termination TXD signal including the transmission data including a parity bit (1) and a stop bit (11) is transmitted to the slave unit 200 via the TXD/CTS terminal 104. In this case, the transmitted transmission data is temporarily stored in the data buffer memory 115. After that, at step S15, a transmission termination processing mode is set, the buffer amplifier 107 is turned OFF, the buffer amplifier 108 is turned ON, and the CTS signal is monitored at the TXD/CTS terminal 104. Then, at step S16, it is judged whether or not the leading edge signal of the CTS signal from the slave unit 200 has been received. If YES at step S16, the control flow proceeds to step S17. On the other hand, if NO at step S16, the control flow returns to step S16. At step S17, it is judged as completion of the data transmission to terminate the data transmission processing. Furthermore, at step S16, for example, a time out function may be provided. In this case, the data transmission processing is terminated by judging as completion of the data transmission when the leading edge signal of the CTS signal has not been detected within an arbitrary time.

Next, the data receiving process executed by the slave unit 200 shown in FIG. 1 will be described below with reference to FIGS. 2 to 4.

At step S101 shown in FIG. 2, an initial setting process is executed as follows. That is, the switch 212 is switched over to the contact “a” side, the buffer amplifier 207 is turned OFF, the buffer amplifier 208 is turned ON, the buffer amplifier 210 is turned OFF, the buffer amplifier 211 is turned ON, and the CTS signal is set to the H level. After that, at step S102, the CTS signal received via the TXD/CTS terminal 204 is monitored. At step S103, it is judged whether or not the trailing edge signal of the CTS signal from the master unit 100 has been received via the TXD/CTS terminal 204. If YES at step S103, the control flow proceeds to step S104. On the other hand, if NO at step S103, the control flow returns to step S102. At step S104, the trailing edge signal of the RTS signal is transmitted to the master unit 100 via the RXD/RTS terminal 205. At step S105, the control flow waits by only time interval corresponding to 1 bit, for example, (that is, a delay time of 1 bit is set), and then, the control flow proceeds to step S106 shown in FIG. 3.

At step S106 shown in FIG. 3, a leading edge signal of the RTS signal is transmitted to the master unit 100 via the RXD/RTS terminal 205. At step S107, the buffer amplifier 211 is turned OFF, the buffer amplifier 208 is turned OFF, and the buffer amplifier 210 is turned ON. And then, a data receiving mode is set at step S108. Further, at step S109, an RXD signal including the transmission data from the master unit 100 is received via the RXD/RTS terminal 205, and then, the control flow proceeds to step S110 shown in FIG. 4.

At step S110 of FIG. 4, it is judged whether or not a notice of termination RXD signal including the transmission data including the parity bit (1) and the stop bit (11) from the master unit 100 has been received via the RXD/RTS terminal 205. If YES at step S110, the control flow proceeds to step s111. On the other hand, if NO at step S110, the control flow proceeds to step S113. In this case, if NO at step S110, it is such a case that logic of the received parity bit 504 is not normal, or the case that the stop bit 502 is not detected. This case is either one of the following cases:

(a) a parity error is detected, such as such a case that a parity bit 504 is “0” and “1” is received in a fixed setting, or such a case that a parity bit 504 is “1” and “0” is received in a fixed setting, or the like; or

(b) a framing error is detected, such as such a case the stop bit 502, which is set to “11”, remains to be “00” and is not detected.

In such cases, the slave unit 200 transits to a reception error state. In this case, since data transmitted by the master unit 100 is not normally transmitted, or normally received by the slave unit 200, the data becomes void, and as a result, missing data is generated. In order to prevent this, a retransmitting process of step S113 is executed.

At step S111 shown in FIG. 4, a receiving termination processing mode is set by judging as completion of receiving, the buffer amplifier 210 is turned OFF, the buffer amplifier 211 is turned ON, while the RTS signal is further changed from the H level to the L level and is further changed to the H level, and then, a leading edge signal of the RTS signal is transmitted to the master unit 100 via the RXD/RTS terminal 205. At step S112, the buffer amplifier 211 is turned OFF, the buffer amplifier 208 is turned ON, and then, the data receiving process is terminated. Meanwhile, at step S113, it is judged as a communication error and, for example, the following communication error processing is executed to terminate the data receiving process. That is, the slave unit 200 becomes the transmission side unit, the master unit 100 becomes the receiving side unit, and the transmission data including the reception error information is transmitted to the master unit 100, then the transmission data is retransmitted during subsequent data transmission from the master unit 100, where a detailed flow is omitted.

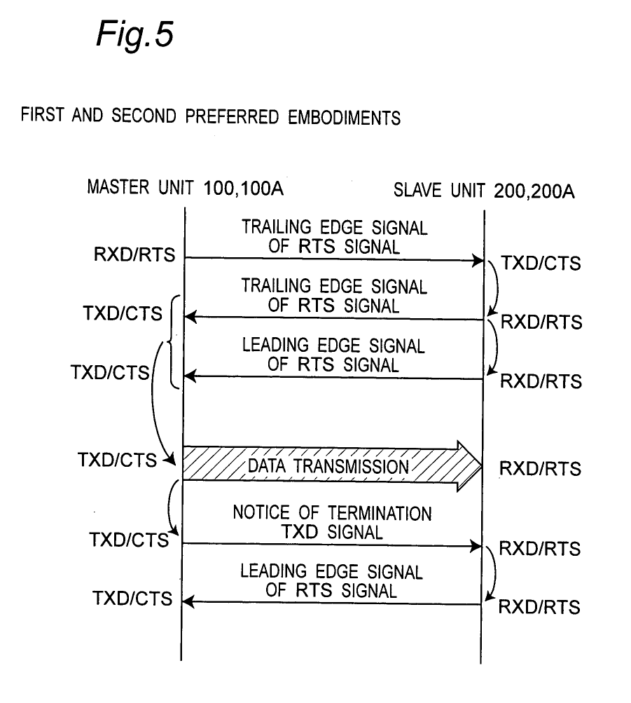

FIG. 5 is a sequence diagram showing a signal transmitting and receiving procedure executed in the bidirectional serial interface system according to the first preferred embodiment, and this sequence diagram is the same as that of a second preferred embodiment to be described later.

Referring to FIG. 5, the master unit 100 transmits the trailing edge signal of the RTS signal to the slave unit 200 via the RXD/RTS terminal 105, and the slave unit 200 receives the trailing edge signal of the RTS signal as the trailing edge signal of the CTS signal via the TXD/CTS terminal 204. In response to the trailing edge signal of the RTS signal, the slave unit 200 transmits the trailing edge signal of the RTS signal to the master unit 100 via the RXD/RTS terminal 205, and the master unit 100 receives the trailing edge signal of the RTS signal as the trailing edge signal of the CTS signal via the TXD/CTS terminal 104. Further, the slave unit 200 transmits the leading edge signal of the RTS signal to the master unit 100 via the RXD/RTS terminal 205, and the master unit 100 receives the leading edge signal of the RTS signal as the leading edge signal of the CTS signal via the TXD/CTS terminal 104. In the master unit 100, when the trailing edge signal of the CTS signal from the slave unit 200 and subsequent leading edge signal of the CTS signal have been received, it is judged as completion of the receiving start-up process of the slave unit 200 and the TXD signal including the transmission data is transmitted to the slave unit 200 via the TXD/CTS terminal 104, and the slave unit 200 receives the TXD signal as the RXD signal via the RXD/RTS terminal 205 and receives the received data included in the RXD signal. Further, when terminating the data transmission, the master unit 100 transmits the above-mentioned notice of termination TXD signal to the slave unit 200 via the TXD/CTS terminal 104, and the slave unit 200 receives the notice of termination TXD signal as the notice of termination RXD signal via the RXD/RTS terminal 205. In response to the notice of termination TXD signal, when the slave unit 200 has normally received the notice of termination RXD signal (YES at step S110 of FIG. 4), the leading edge signal of the RTS signal is transmitted to the master unit 100 via the RXD/RTS terminal 205, and the master unit 100 receives the leading edge signal of the RTS signal as the leading edge signal of the CTS signal and detects a normal receiving termination of the slave unit 200 to terminate the above-mentioned data communication.

Although the above-described data transmission and receiving process shown in FIGS. 2 to 5 describes the case that data is transmitted from the master unit 100 to the slave unit 200, the master unit 100 and the slave unit 200 have the same configuration, thus, data can be transmitted from the slave unit 200 to the master unit 100 by changing the two apparatuses 100 and 200 from transmission to reception and vice versa.

As described above, according to the bidirectional serial interface system of the preferred embodiment, half-duplex, bidirectional, asynchronous serial data communication equivalent to a UART interface related to the prior art can be realized using two signal terminals which are less in number as compared with the prior art, and this leads to that hardware of the apparatuses 100 and 200 can be largely reduced in cost.

### Second Preferred Embodiment

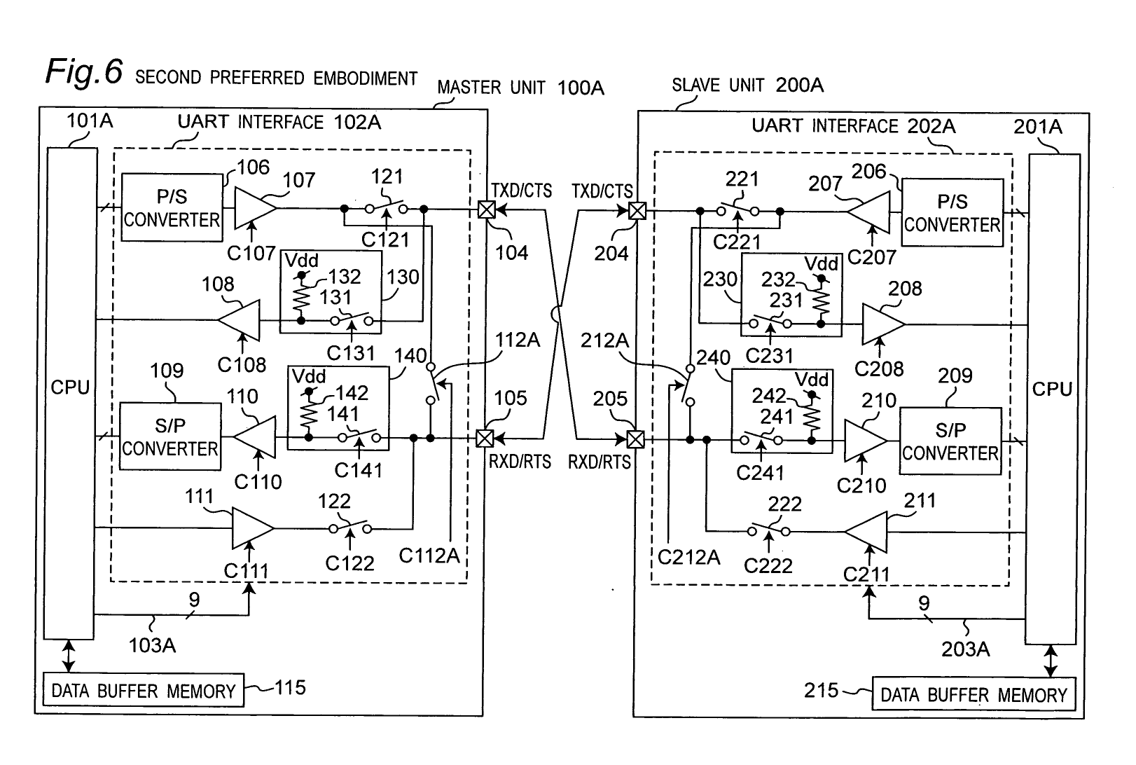

FIG. 6 is a block diagram showing a configuration of a bidirectional serial interface system composed of a master unit 100A and a slave unit 200A according to a second preferred embodiment of the present invention. The bidirectional serial interface system according to the second preferred embodiment shown in FIG. 6 differs in the following points as compared with the bidirectional serial interface system according to the first preferred embodiment shown in FIG. 1:

(a) The master unit 100A includes a CPU 101A in place of the CPU 101, and the slave unit 200A includes a CPU 201A in place of the CPU 201;

(b) The master unit 100A includes a UART interface 102A in place of the UART interface 102, and the slave unit 200A includes a UART interface 202A in place of the UART interface 202;

(b1) In order to make the UART interface 102A operate even when the master unit 100A and the slave unit 200A are different in source voltage, level adjusting circuits 130 and 140 for adjusting an output voltage to a predetermined voltage and outputting the output voltage are further provided. In this case, the level adjusting circuit 130 includes a switch 131, which is ON/OFF controlled by a control signal C131, and a pull-up resistor 132. The level adjusting circuit 140 includes a switch 141, which is ON/OFF controlled by a control signal C141, and a pull-up resistor 142;

(b2) The UART interface 102A further includes switches 121 and 122, which are ON/OFF controlled by control signals C121 and C122, respectively, and a switch 112A for the loopback test of the self-apparatus, which is ON/OFF controlled by a control signal C112A, is provided in place of the switch 112 for the loopback test of the self-apparatus;

(b3) In order to make the UART interface 202A operate even when the master unit 100A and the slave unit 200A are different in source voltage, level adjusting circuits 230 and 240 for adjusting an output voltage to a predetermined voltage and output the output voltage are further provided. In this case, the level adjusting circuit 230 includes a switch 231, which is ON/OFF controlled by a control signal C231, and a pull-up resistor 232. The level adjusting circuit 240 includes a switch 241, which is ON/OFF controlled by a control signal C241, and a pull-up resistor 242; and

(b4) The UART interface 202A further includes switches 221 and 222, which are ON/OFF controlled by control signals C121 and C222, respectively, and a switch 212A for the loopback test of the self-apparatus, which is ON/OFF controlled by a control signal C212A, is provided in place of the switch 212 for the loopback test of the self-apparatus. In addition, it is preferable that the switches 131, 141, 121, 122, 231, 241, 221 and 222 have a backflow prevention type switch configuration.

First of all, the different points from the circuit configuration of the master unit 100A will be described in detail below. An output terminal of the buffer amplifier 107 is connected to the TXD/CTS terminal 104 via the switch 121 and also connected to the RXD/RTS terminal 105 via the switch 112A. Furthermore, the TXD/CTS terminal 104 is connected to an input terminal of the buffer amplifier 108 via the switch 131 of the level adjusting circuit 130, the input terminal of the buffer amplifier 108 is connected to a source voltage Vdd via a pull-up resistor 132, and the input terminal is pulled up to the source voltage Vdd, and thus the switch 131 is turned ON to level-adjust the terminal potential of the switch 131 to the source voltage Vdd even when the terminal potential of the switch 131 is less than the source voltage Vdd. Further, an output terminal of the buffer amplifier 111 is connected to the RXD/RTS terminal 105 via the switch 122, the RXD/RTS terminal 105 is connected to an input terminal of the buffer amplifier 110 via the switch 141 of the level adjusting circuit 140, the input terminal of the buffer amplifier 110 is connected to the source voltage Vdd via the pull-up resistor 142, and the input terminal is pulled up to the source voltage Vdd, and thus the switch 141 is turned ON to level-adjust the terminal potential of the switch 141 to the source voltage Vdd even when the terminal potential of the switch 141 is less than the source voltage Vdd. The control line 103A from the CPU 101A to the UART interface 102A includes the control signal C121 provided to the switch 121, the control signal C122 provided to the switch 122, the control signal C131 provided to the switch 131, the control signal C141 provided to the switch 141, and the control signal C112A provided to the switch 112A, in addition to the control signals C107, C108, C110 and C111.

Next, the different points from the circuit configuration of the slave unit 200A will be described in detail below. An output terminal of the buffer amplifier 207 is connected to the TXD/CTS terminal 204 via the switch 221 and also connected to the RXD/RTS terminal 205 via the switch 212A. Furthermore, the TXD/CTS terminal 204 is connected to an input terminal of the buffer amplifier 208 via the switch 231 of the level adjusting circuit 230, the input terminal of the buffer amplifier 208 is connected to a source voltage Vdd via a pull-up resistor 232, and the input terminal is pulled up to the source voltage Vdd, and thus the switch 231 is turned ON to level-adjust the terminal potential of the switch 231 to the source voltage Vdd even when the terminal potential of the switch 231 is less than the source voltage Vdd. Further, an output terminal of the buffer amplifier 211 is connected to the RXD/RTS terminal 205 via the switch 222, the RXD/RTS terminal 205 is connected to an input terminal of the buffer amplifier 210 via the switch 241 of the level adjusting circuit 240, the input terminal of the buffer amplifier 210 is connected to the source voltage Vdd via the pull-up resistor 242, and the input terminal is pulled up to the source voltage Vdd, and thus the switch 241 is turned ON to level-adjust the terminal potential of the switch 241 to the source voltage Vdd even when the terminal potential of the switch 241 is less than the source voltage Vdd. The control line 203A from the CPU 201A to the UART interface 202A includes the control signal C221 provided to the switch 221, the control signal C222 provided to the switch 222, the control signal C231 provided to the switch 231, the control signal C241 provided to the switch 241, and the control signal C212A provided to the switch 212A, in addition to the control signals C207, C208, C210 and C211.

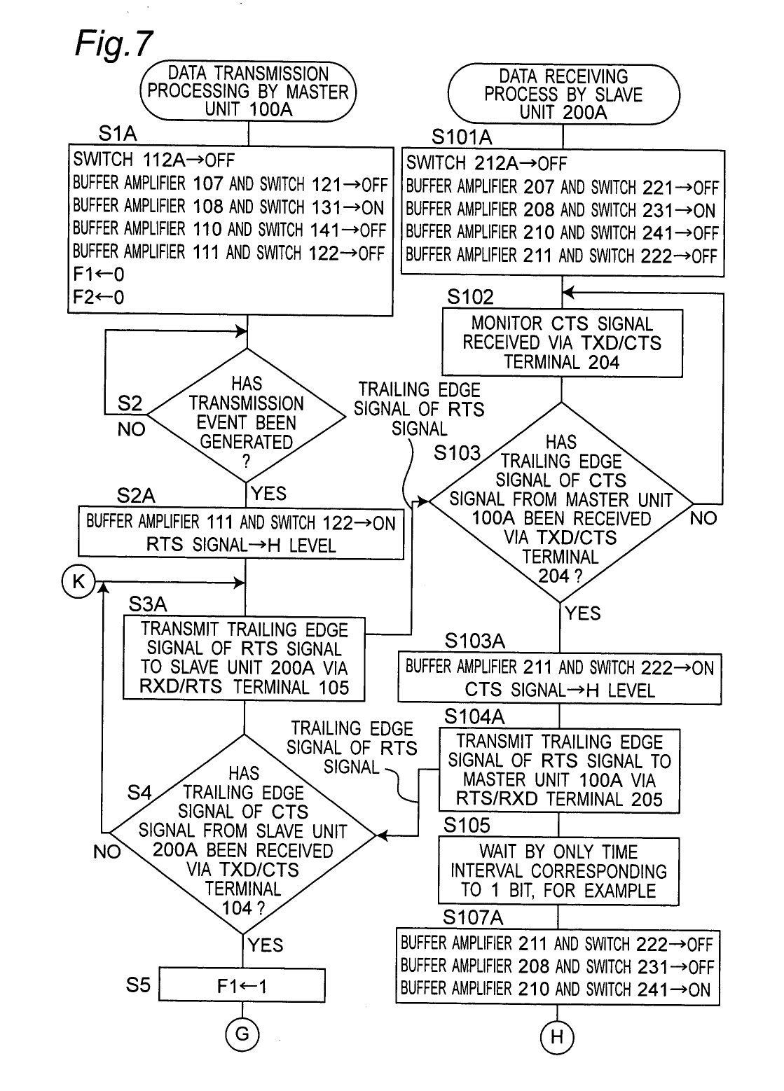

The data communication processing of the bidirectional serial interface system configured as described above will be described below with reference to FIGS. 7 to 9. FIGS. 7 to 9 are flow charts showing the data transmission processing executed by the master unit 100A shown in FIG. 6 and a data receiving process executed by the slave unit 200A shown in FIG. 6.

First of all, the data transmission processing executed by the master unit 100A shown in FIG. 6 will be described below with reference to FIGS. 7 to 9.

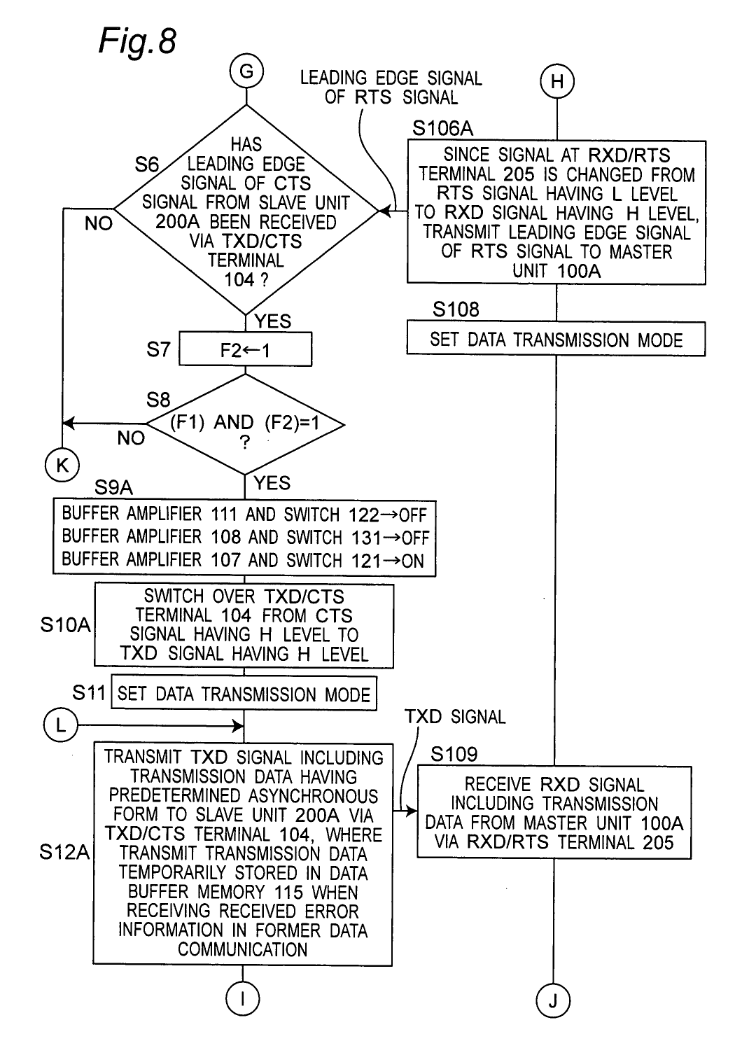

At step S1A shown in FIG. 7, an initial setting process is executed as follows. That is, the switch 112A is turned OFF, the buffer amplifier 107 and the switch 121 are turned OFF, the buffer amplifier 108 and the switch 131 are turned ON, the buffer amplifier 110 and the switch 141 are turned OFF, the buffer amplifier 111 and the switch 122 are turned OFF, a receiving flag F1 is reset to 0, and a receiving flag F2 is reset to 0. After that, at step S2, it is judged whether or not a transmission event has been generated, and processing of step S2 is repeated till a YES judgment is made. If YES at step S2, at step S2A, the buffer amplifier 111 and the switch 122 are turned ON and the RTS signal is changed to the H level. Then, at step S3A, the trailing edge signal of the RTS signal is transmitted to the slave unit 200A via the RXD/RTS terminal 105. At step S4, it is judged whether or not the trailing edge signal of the CTS signal from the slave unit 200A has been received via the TXD/CTS terminal 104. If YES at step S4, the control flow proceeds to step S5. On the other hand, if NO at step S4, the control flow returns to step S3A. At step S5, the receiving flag F1 is set to 1, and then, the control flow proceeds to step S6 shown in FIG. 8.

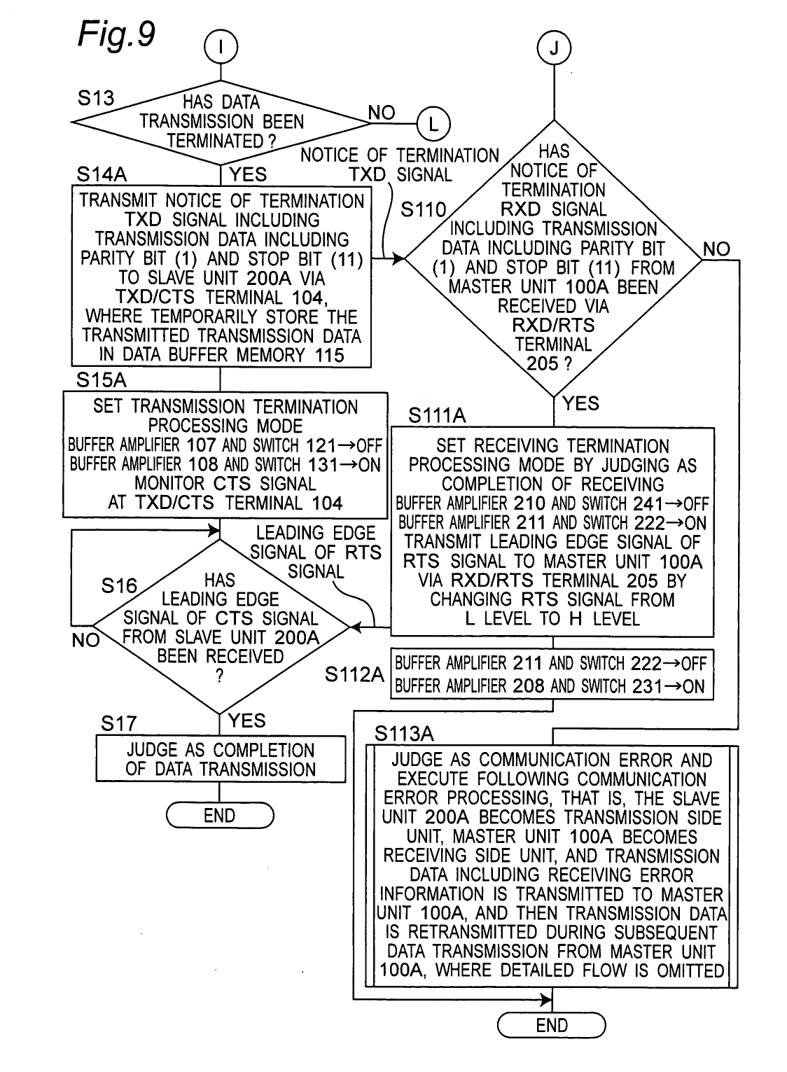

At step S6 of FIG. 8, it is judged whether or not a leading edge signal of the CTS signal from the slave unit 200A has been received via the TXD/CTS terminal 104. If YES at step S6, the control flow proceeds to step S7. On the other hand, if NO at step S6, the control flow returns to step S3A. After that, at step S7, the receiving flag F2 is set to 1. At step S8, it is judged whether or not logical AND of the receiving flag F1 and the receiving flag F2 is 1. If YES at step S8, the control flow proceeds to step S9A. On the other hand, if NO at step S8, the control flow returns to step S3A. At step S9A, the buffer amplifier 111 and the switch 122 are turned OFF, the buffer amplifier 108 and the switch 131 are turned OFF, and the buffer amplifier 107 and the switch 121 are turned ON. After that, at step S10A, the TXD/CTS terminal 104 is switched over from a CTS signal having the H level to a TXD signal having the H level. Then, at step S11, a data transmission mode is set, and the control flow proceeds to step S12A. At step S12A, a TXD signal including the transmission data having a predetermined asynchronous form is transmitted to the slave unit 200A via the TXD/CTS terminal 104. It is noted that the transmission data temporarily stored in the data buffer memory 115 is transmitted when the reception error information is received in the former data communication. After that, the control flow proceeds to step S13 shown in FIG. 9.

At step S13 shown in FIG. 9, it is judged whether or not the data transmission has been terminated. If YES at step S13, the control flow proceeds to step S14A. On the other hand, if NO at step S13, the control flow returns to step S12A. At step S14A, a notice of termination TXD signal including the transmission data including a parity bit (1) and a stop bit (11) is transmitted to the slave unit 200A via the TXD/CTS terminal 104. In this case, the transmitted transmission data is temporarily stored in the data buffer memory 115. After that, at step S15A, a transmission termination processing mode is set, the buffer amplifier 107 and the switch 121 are turned OFF, the buffer amplifier 108 and the switch 131 are turned ON, and the CTS signal is monitored at the TXD/CTS terminal 104. Then, at step S16, it is judged whether or not the leading edge signal of the CTS signal from the slave unit 200A has been received. If YES at step S16, the control flow proceeds to step S17. On the other hand, if NO at step S16, the control flow returns to step S16 and the processing of step S16 is repeated. At step S17, it is judged as completion of the data transmission to terminate the data transmission processing. Furthermore, at step S16, for example, a time out function may be provided. In this case, the data transmission processing is terminated by judging as completion of the data transmission when the leading edge signal of the CTS signal has not been detected within an arbitrary time.

Next, the data receiving process executed by the slave unit 200A shown in FIG. 6 will be described below with reference to FIGS. 7 to 9.

At step S101A shown in FIG. 7, an initial setting process is executed as follows. The switch 212A is turned OFF, the buffer amplifier 207 and the switch 221 are turned OFF, the buffer amplifier 208 and the switch 231 are turned ON, the buffer amplifier 210 and the switch 241 are turned OFF, and the buffer amplifier 211 and the switch 222 are turned OFF. After that, at step S102, the CTS signal received via the TXD/CTS terminal 204 is monitored. At step S103, it is judged whether or not the trailing edge signal of the CTS signal from the master unit 100A has been received via the TXD/CTS terminal 204. If YES at step S103, the control flow proceeds to step S103A. On the other hand, if NO at step S103, the control flow returns to step S102. At step S103A, the buffer amplifier 211 and the switch 222 are turned ON, and the CTS signal is changed to the H level. After that, at step S104A, the trailing edge signal of the RTS signal is transmitted to the master unit 100A via the RXD/RTS terminal 205. At step S105, the control flow waits by only time interval corresponding to 1 bit, for example. That is, for example, after one bit of delay time is set. At step S107A, the buffer amplifier 211 and the switch 222 are turned OFF, the buffer amplifier 208 and the switch 231 are turned OFF, the buffer amplifier 210 and the switch 241 are turned ON, and the control flow proceeds to step S106A shown in FIG. 8.

At step S106A shown in FIG. 8, since the signal at the RXD/RTS terminal 205 is changed from the RTS signal having the L level to the RXD signal having the H level, a leading edge signal of the RTS signal is transmitted to the master unit 100A. At step S108, a data receiving mode is set. After that, at step S109, an RXD signal including the transmission data from the master unit 100A is received via the RXD/RTS terminal 205, and the control flow proceeds to step S110 shown in FIG. 9.

At step S110 shown in FIG. 9, it is judged whether or not a notice of termination RXD signal including the transmission data including the parity bit (1) and the stop bit (11) from the master unit 100A has been received via the RXD/RTS terminal 205. If YES at step S110, the control flow proceeds to step S111A. On the other hand, if NO at step S110, the control flow proceeds to step S113A. At step S111A, a receiving termination processing mode is set by judging as completion of receiving, the buffer amplifier 210 and the switch 241 are turned OFF, the buffer amplifier 211 and the switch 222 are turned ON, and the RTS signal is changed from the L level to the H level, and then, the leading edge signal of the RTS signal is transmitted to the master unit 100A via the RXD/RTS terminal 205. At step S112A, the buffer amplifier 211 and the switch 222 are turned OFF, the buffer amplifier 208 and the switch 231 are turned ON, and the data receiving process is terminated. Meanwhile, at step S113A, it is judged as a communication error and, for example, the following communication error processing is executed to terminate the data receiving process. That is, the slave unit 200A becomes the transmission side unit, the master unit 100A becomes the receiving side unit, and the transmission data including the reception error information is transmitted to the master unit 100A, and then, the transmission data is retransmitted during subsequent data transmission from the master unit 100A, where a detailed flow is omitted.

FIG. 5 is a sequence diagram showing a signal transmitting and receiving procedure executed in the bidirectional serial interface system according to the second preferred embodiment as in the above-mentioned description.

The above-described data transmission and receiving process shown in FIGS. 7 to 9 describes the case that data is transmitted from the master unit 100A to the slave unit 200A. However, since the master unit 100A and the slave unit 200A have the same configuration, data can be transmitted from the slave unit 200A to the master unit 100A by changing the two apparatuses 100A and 200A from transmission to reception and vice versa.

As described above, according to the bidirectional serial interface system of the preferred embodiment, half-duplex, bidirectional, asynchronous serial data communication equivalent to a UART interface related to the prior art can be realized using two signal terminals which are less in number as compared with the prior art, and this leads to that hardware of the apparatuses 100A and 200A can be largely reduced in cost.

### Third Preferred Embodiment

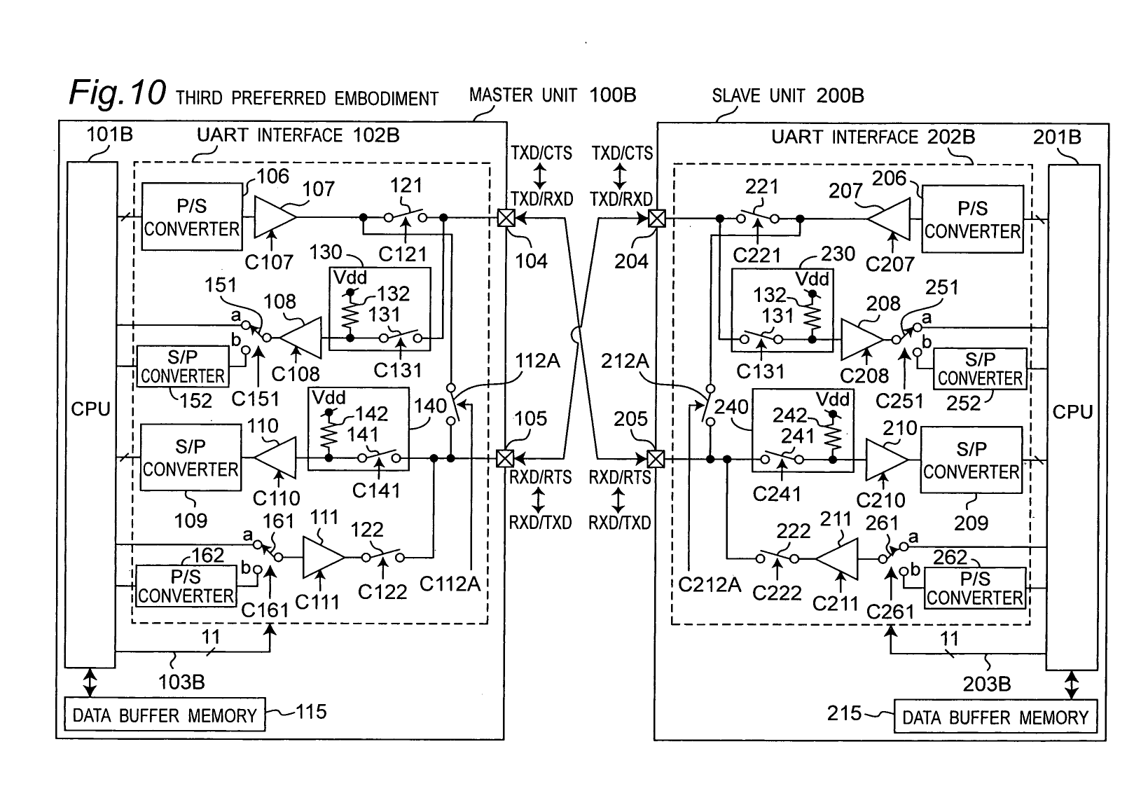

FIG. 10 is a block diagram showing a configuration of a bidirectional serial interface system composed of a master unit 100B and a slave unit 200B according to a third preferred embodiment of the present invention. The bidirectional serial interface system according to the third preferred embodiment shown in FIG. 10 differs in the following points as compared with the bidirectional serial interface system according to the second preferred embodiment shown in FIG. 6:

(a) The master unit 100B includes the CPU 101B in place of the CPU 101A, and the slave unit 200B includes a CPU 201B in place of the CPU 201A;

(b) The master unit 100B includes a UART interface 102B in place of the UART interface 102A, and the slave unit 200B includes a UART interface 202B in place of the UART interface 202A;

(b1) In the UART interface 102A, a selector 151 and an S/P converter 152 are inserted between the CPU 101A and an output terminal of the buffer amplifier 108, and a selector 161 switched by a control signal C151 and an S/P converter 162 are inserted between the CPU 101A and an input terminal of the buffer amplifier 111. That is, a signal outputted from the output terminal of the buffer amplifier 108 is outputted to the CPU 101B via a contact “a” side of the selector 151 and is outputted to the CPU 101B via a contact “b” side of the selector 151 and the S/P converter 152;

(b2) In the UART interface 202A, a selector 251 and an S/P converter 252 are inserted between the CPU 201A and an output terminal of the buffer amplifier 208, and a selector 261 switched by a control signal C251 and an S/P converter 262 are inserted between the CPU 201A and an input terminal of the buffer amplifier 211. That is, a signal outputted from the output terminal of the buffer amplifier 208 is outputted to the CPU 201B via a contact “a” side of the selector 251, and is outputted to the CPU 201B via a contact “b” side of the selector 251 and the S/P converter 252;

(b3) The control line 103B from the CPU 101B to the UART interface 102B includes control signals C151 and C161 in addition to control signals C107, C108, C110, C11, C121, C122, C131, C141 and C112A; and

(b4) The control line 203B from the CPU 201B to the UART interface 202B includes control signals C251 and C261 in addition to control signals C207, C208, C210, C211, C221, C222, C 231, C241 and C212A.

In the master unit 100B configured as described above, a signal terminal 104 is used by selectively switching a TXD/CTS terminal and a TXD/RXD terminal, and a signal terminal 105 is used by selectively switching an RXD/RTS terminal and an RXD/TXD terminal. Furthermore, in the slave unit 200B, a signal terminal 204 is used by selectively switching a TXD/CTS terminal and a TXD/RXD terminal, and a signal terminal 205 is used by selectively switching an RXD/RTS terminal and an RXD/TXD terminal. It is characterized in that, in this preferred embodiment, the bidirectional serial interface system is configured as described above, thus dual and simultaneous data transmission and receiving mode processes can be made as to be described below.

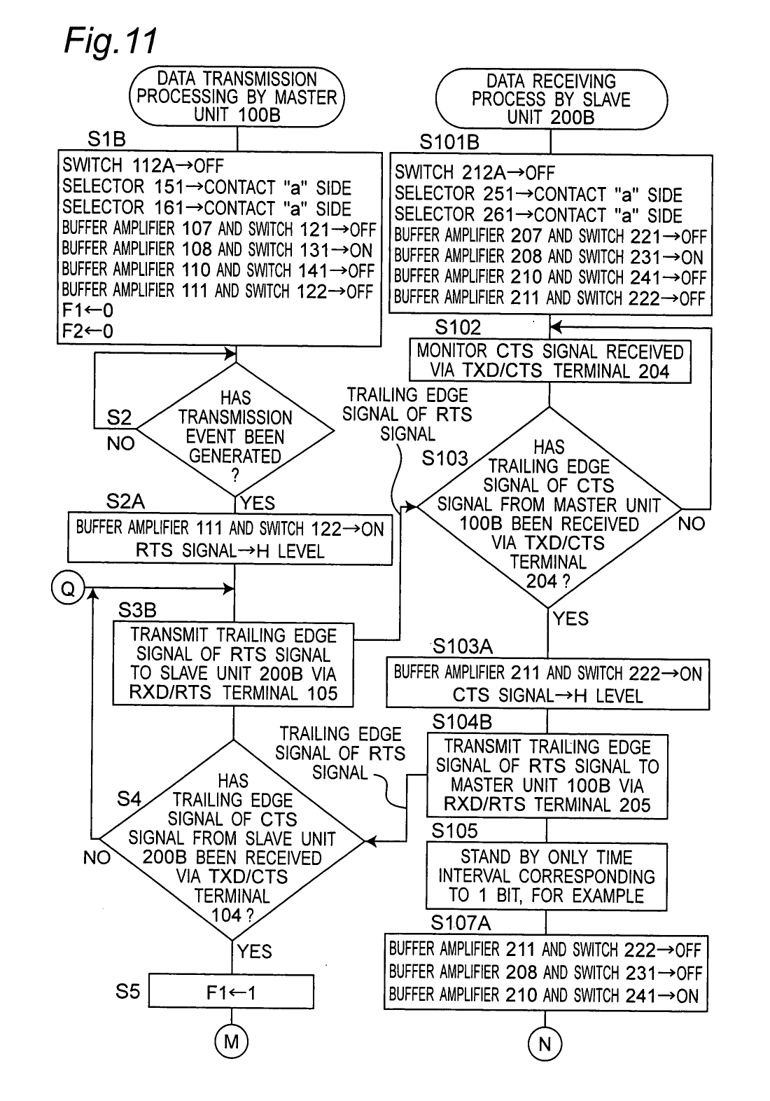

The data communication processing of the bidirectional serial interface system configured as described above will be described below with reference to FIGS. 11 to 14. FIGS. 11 to 14 are flow charts showing the data transmission and receiving process executed by the master unit 100B shown in FIG. 10 and the data transmission and receiving process executed by the slave unit 200B shown in FIG. 10.

First of all, the data transmission and receiving process executed by the master unit 100B shown in FIG. 10 will be described below with reference to FIGS. 11 to 14.

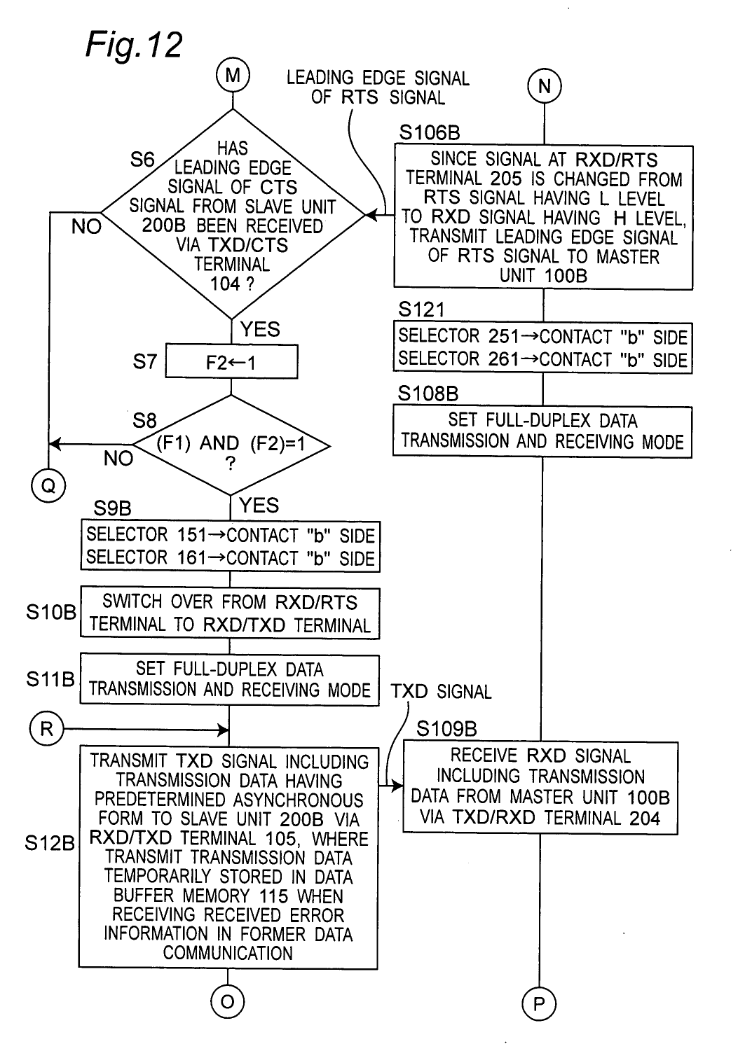

At step S1A shown in FIG. 7, an initial setting process is executed as follows. That is, the switch 112A is turned OFF, the selector 151 is switched over to the contact “a” side, the selector 161 is switched over to the contact “a” side, the buffer amplifier 107 and the switch 121 are turned OFF, the buffer amplifier 108 and the switch 131 are turned ON, the buffer amplifier 110 and the switch 141 are turned OFF, the buffer amplifier 111 and the switch 122 are turned OFF, a receiving flag F1 is reset to 0, and a receiving flag F2 is reset to 0. After that, at step S2, it is judged whether or not a transmission event has been generated, and processing of step S2 is repeated till a YES judgment is made. If YES at step S2, the control flow proceeds to step S2A. At step S2A, the buffer amplifier 111 and the switch 122 are turned ON and the RTS signal is changed to the H level, and then, at step S3B, a trailing edge signal of the RTS signal is transmitted to the slave unit 200B via the RXD/RTS terminal 105. At step S4, it is judged whether or not the trailing edge signal of the CTS signal from the slave unit has been received via the TXD/CTS terminal 104. If YES at step S4, the control flow proceeds to step S5. On the other hand, if NO at step S4, the control flow returns to step S3B. At step S5, the receiving flag F1 is set to 1, and then, the control flow proceeds to step S6 shown in FIG. 12.

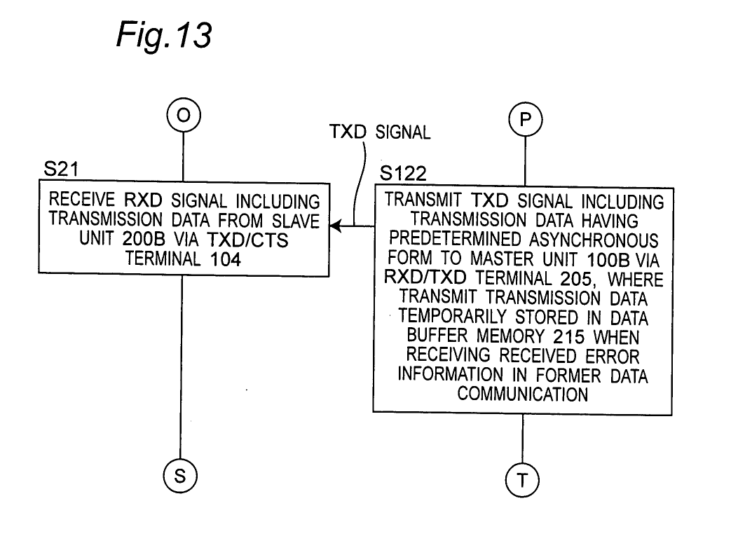

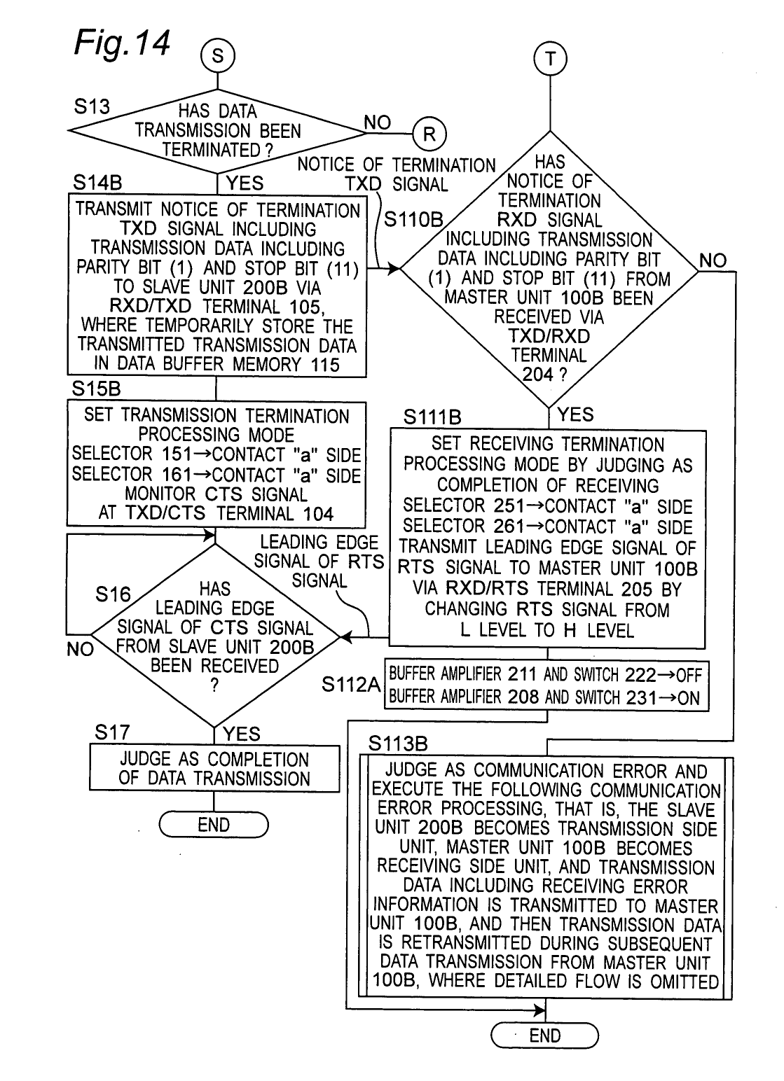

At step S6 shown in FIG. 12, it is judged whether or not a leading edge signal of the CTS signal from the slave unit 200B has been received via the TXD/CTS terminal 104. If YES at step S6, the control flow proceeds to step S7. On the other hand, if NO at step S6, the control flow returns to step S3B. At step S7, the receiving flag F2 is set to 1. At step S8, it is judged whether or not logical AND of the receiving flag F1 and the receiving flag F2 is 1. If YES at step S8, the control flow proceeds to step S9B. On the other hand, if NO at step S8, the control flow returns to step S3B. At step S9B, the selector 151 is switched over to the contact “b” side, the selector 161 is switched over to the contact “b” side. At step S10B, it is changed over from the RXD/RTS terminal to the RXD/TXD terminal. And then, at step S11B, a full-duplex data transmission and receiving mode is set. Then, at step S12B, a TXD signal including the transmission data having a predetermined asynchronous form is transmitted to the slave unit 200B via the RXD/TXD terminal 105. It is noted that the transmission data temporarily stored in the data buffer memory 115 is transmitted when the reception error information is received in the former data communication. Then, the control flow proceeds to step S21 in FIG. 13. At step S21 shown in FIG. 13, an RXD signal including the transmission data from the slave unit 200B is received via the TXD/RXD terminal 104, and the control flow proceeds to step S13 shown in FIG. 14. In this case, the processing shown at step S12B and step S21 may be executed simultaneously, and this leads to that processing of the full-duplex data transmission and receiving mode can be performed.

At step S13 shown in FIG. 14, it is judged whether or not the data transmission has been terminated. If YES at step S13, the control flow proceeds to step S14B. On the other hand, if NO at step S13, the control flow returns to step S12B. At step S14B, a notice of termination TXD signal including the transmission data including a parity bit (1) and a stop bit (11) is transmitted to the slave unit 200B via the RXD/TXD terminal 105. In this case, the transmitted transmission data is temporarily stored in the data buffer memory 115. After that, at step S15B, a transmission termination processing mode is set, the selector 151 is switched over to the contact “a” side, the selector 161 is switched over to the contact “a” side, and the CTS signal is monitored at the TXD/CTS terminal 104. At step S16, it is judged whether or not the leading edge signal of the CTS signal from the slave unit 200B has been received. If YES at step S16, the control flow proceeds to step S17. On the other hand, if NO at step S16, the control flow returns to step S16 and the processing of step S16 is repeated. At step S17, it is judged as completion of the data transmission to terminate the data transmission processing. Furthermore, at step S16, for example, a time out function may be provided. In this case, the data transmission processing is terminated by judging as completion of the data transmission when the leading edge signal of the CTS signal has not been detected within an arbitrary time.

Next, the data transmission and receiving process executed by the slave unit 200B shown in FIG. 10 will be described below with reference to FIGS. 11 to 14.

At step S101B shown in FIG. 11, an initial setting process is executed as follows. That is, the switch 212A is turned OFF, the selector 251 is switched over to the contact “a” side and the selector 261 is switched over to the contact “a” side, the buffer amplifier 207 and the switch 221 are turned OFF, the buffer amplifier 208 and the switch 231 are turned ON, the buffer amplifier 210 and the switch 241 are turned OFF, and the buffer amplifier 211 and the switch 222 are turned OFF. After that, at step S102, the CTS signal received via the TXD/CTS terminal 204 is monitored. At step S103, it is judged whether or not the trailing edge signal of the CTS signal from the master unit 100B has been received via the TXD/CTS terminal 204. If YES at step S103, the control flow proceeds to step S103A. On the other hand, if NO at step S103, the control flow returns to step S102. At step S103A, the buffer amplifier 211 and the switch 222 are turned ON and the CTS signal is changed to the H level, and then, at step S104B, the trailing edge signal of the RTS signal is transmitted to the master unit 100B via the RXD/RTS terminal 205. At step S105, the control flow waits by only time interval corresponding to one bit, for example. That is, one bit of delay time is set. At step S107A, the buffer amplifier 211 and the switch 222 are turned OFF, the buffer amplifier 208 and the switch 231 are turned OFF, the buffer amplifier 210 and the switch 241 are turned ON, and the control flow proceeds to step S106B shown in FIG. 12.

At step S106B shown in FIG. 12, since the signal at the RXD/RTS terminal 205 is changed from the RTS signal having the L level to the RXD signal having the H level, a leading edge signal of the RTS signal is transmitted to the master unit 100B. Then, at step S121, the selector 251 is switched over to the contact “b” side, the selector 261 is switched over to the contact “b” side. At step S108B, the full-duplex data transmission and receiving mode is set. Then, at step S109B, an RXD signal including the transmission data from the master unit 100B is received via the TXD/RXD terminal 204, and then, the control flow proceeds to step S122 shown in FIG. 13. At step S122 shown in FIG. 13, a TXD signal including the transmission data having a predetermined asynchronous form is transmitted to the master unit 100B via the RXD/TXD terminal 205. It is noted that the transmission data temporarily stored in the data buffer memory 215 is transmitted when the reception error information is received in the former data communication, and then, the control flow proceeds to step S110B shown in FIG. 14. In this case, the processing of step S109B and step S122 may be executed simultaneously, and this leads to that processing of the full-duplex data transmission and receiving mode can be performed.

At step S110B shown in FIG. 14, it is judged whether or not a notice of termination RXD signal including the transmission data including the parity bit (1) and the stop bit (11) from the master unit 100B has been received via the TXD/RXD terminal 204. If YES at step S110B, the control flow proceeds to step S111B. On the other hand, if NO at step S110B, the control flow proceeds to step S113B. At step S111B, a receiving termination processing mode is set by judging as completion of receiving, the selector 251 is switched over to the contact “a” side, the selector 261 is switched over to the contact “a” side, and the RTS signal is changed from the L level to the H level, and then, the leading edge signal of the RTS signal is transmitted to the master unit 100B via the RXD/RTS terminal 205. At step S112A, the buffer amplifier 211 and the switch 222 are turned OFF, the buffer amplifier 208 and the switch 231 are turned ON, and the data receiving process is terminated. Meanwhile, at step S113B, it is judged as a communication error and, for example, the following communication error processing is executed to terminate the data receiving process. That is, the slave unit 200B becomes the transmission side unit, the master unit 100B becomes the receiving side unit, and the transmission data including the reception error information is transmitted to the master unit 100B, and then, the transmission data is retransmitted during subsequent data transmission from the master unit 100B, where a detailed flow is omitted.

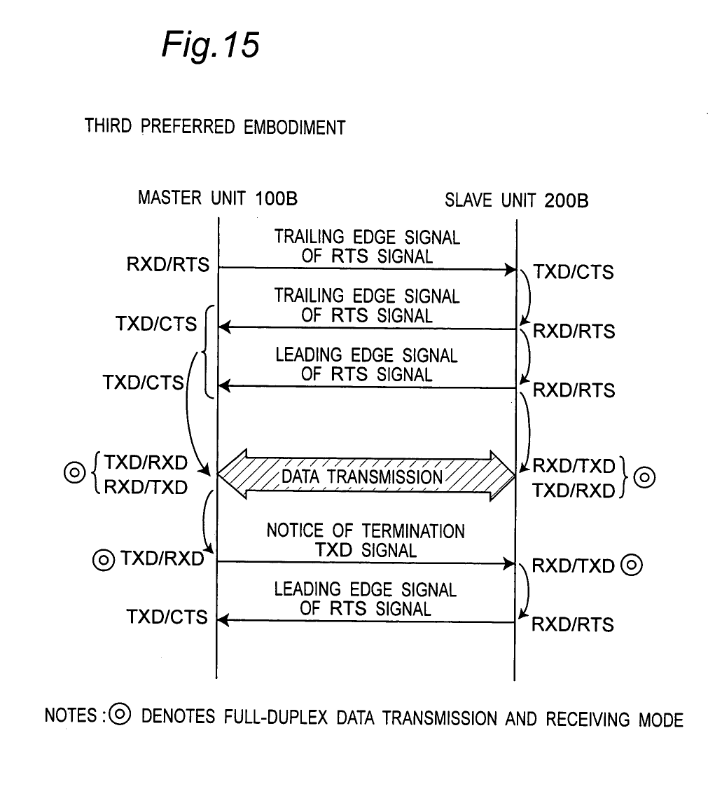

FIG. 15 is a sequence diagram showing a signal transmitting and receiving procedure executed in the bidirectional serial interface system according to the third preferred embodiment.

Referring to FIG. 15, the master unit 100B transmits the trailing edge signal of the RTS signal to the slave unit 200B via the RXD/RTS terminal 105, and the slave unit 200B receives the trailing edge signal of the RTS signal as a trailing edge signal of the CTS signal via the TXD/CTS terminal 204. In response to the trailing edge signal of the RTS signal, the slave unit 200B transmits the trailing edge signal of the RTS signal to the master unit 100B via the RXD/RTS terminal 205, and the master unit 100B receives the trailing edge signal of the RTS signal as the trailing edge signal of the CTS signal via the TXD/CTS terminal 104. Further, the slave unit 200B transmits the leading edge signal of the RTS signal to the master unit 100B via the RXD/RTS terminal 205, and the master unit 100B receives the leading edge signal of the RTS signal as the leading edge signal of the CTS signal via the TXD/CTS terminal 104. In the master unit 100B, when the trailing edge signal of the CTS signal from the slave unit 200B and subsequent leading edge signal of the CTS signal have been received, it is judged as completion of the receiving start-up process of the slave unit 200B and the TXD signal including the transmission data is transmitted to the slave unit 200B via the RXD/CTS terminal 104, and the slave unit 200B receives the TXD signal as the RXD signal via the RXD/RTS terminal 205 and receives the received data included in the RXD signal. In this case, it is possible to perform the data transmission from the following slave unit 200B to the master unit 100B. That is, the slave unit 200B transmits the TXD signal including the transmission data to the master unit 100B via the TXD/CTS terminal 204, and the master unit 100B receives the TXD signal as the RXD signal via the RXD/RTS terminal 105 and receives the received data included in the RXD signal. Therefore, the master unit 100B and the slave unit 200B can execute processing of the full-duplex data transmission and receiving mode. Further, when terminating the data transmission, the master unit 100B transmits the above-mentioned notice of termination TXD signal to the slave unit 200B via the TXD/CTS terminal 104, and the slave unit 200B receives the notice of termination TXD signal as the notice of termination RXD signal via the RXD/RTS terminal 205. In response to it, when the slave unit 200B has normally received the notice of termination RXD signal (YES at step S110B shown in FIG. 14), the leading edge signal of the RTS signal is transmitted to the master unit 100B via the RXD/RTS terminal 205, and the master unit 100B receives the leading edge signal of the RTS signal as the leading edge signal of the CTS signal and detects a normal receiving termination of the slave unit 200B to terminate the above-mentioned data communication.

The above-described data transmission and receiving process shown in FIGS. 11 to 15 describes the case that data is transmitted starting from the master unit 100B to the slave unit 200B in full-duplex mode. However, since the master unit 100B and the slave unit 200B have the same configuration, data can be transmitted starting from the slave unit 200B to the master unit 100B by changing the two apparatuses 100B and 200B from transmission to reception and vice versa, and this leads to that full-duplex data can be transmitted starting from the slave unit 200B to the master unit 100B.

As described above, according to the bidirectional serial interface system of the preferred embodiment, full-duplex, bidirectional, asynchronous serial data communication can be realized using two signal terminals which are less in number as compared with the prior art, and this leads to that hardware of the apparatuses 100B and 200B can be largely reduced in cost.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. A serial interface apparatus comprising:
a controller for generating a parallel data signal and a control signal, and performing communication control;
a parallel to serial converter for converting a parallel data signal to be transmitted from said controller, into a serial data signal;
a data transmitting terminal for transmitting the converted serial data signal to other side apparatus;
a data receiving terminal for receiving the serial data signal from said other side apparatus;
a serial to parallel converter for converting the received serial data signal into a parallel data signal, and outputting the parallel data signal to said controller;
a first control signal terminal for transmitting a first control signal for confirmation of transmission request from said controller to said other side apparatus; and
a second control signal terminal for receiving a second control signal indicating confirmation of possibly receiving from said other side apparatus, and outputting the received second control signal to said controller;
wherein said serial interface apparatus further comprises:
a first signal terminal for sharing said data transmitting terminal and the second control signal terminal;
a second signal terminal for sharing said data receiving terminal and the first control signal terminal;
a first buffer amplifier for buffer-amplifying the converted serial data signal, and outputting a buffer-amplified serial data signal to said first signal terminal;
a second buffer amplifier for buffer-amplifying the serial data signal received via said second signal terminal, and outputting a buffer-amplified serial data signal to said serial to parallel converter;
a third buffer amplifier for buffer-amplifying the first control signal, and outputting a buffer-amplified first control signal to said second signal terminal; and
a fourth buffer amplifier for buffer-amplifying the received second control signal via said first signal terminal, and outputting a buffer-amplified second control signal to said controller,
wherein, upon receiving two types of second control signals different from each other from said other side apparatuses after transmitting the first control signal to said other side apparatus, said controller executes half-duplex data communication using said two signal terminals by transmitting the serial data signal to said other side apparatus via said first signal terminal, transmitting to said first signal terminal a serial data signal indicating a notice of termination upon end of the serial data signal to be transmitted, and judging as a data communication termination upon reception of the second control signal from said other side apparatus in response to the transmission of the serial data signal.

2. The serial interface apparatus as claimed in claim 1, further comprising:
a first level adjusting circuit, disposed between said first signal terminal and said fourth buffer amplifier, for adjusting a level of the second control signal received via said first signal terminal to be a predetermined level; and
a second level adjusting circuit, disposed between said second signal terminal and said second buffer amplifier, for adjusting a level of the serial data signal received via said second signal terminal to be a predetermined level.

3. The serial interface apparatus as claimed in claim 1, further comprising:
a further parallel to serial converter for converting the parallel data signal to be transmitted from said a controller, into a serial data signal;
a further serial to parallel converter for converting the received serial data signal into a parallel data signal, and outputting the parallel data signal to said controller;
a first selector for selecting the first control signal from said controller and outputting the selected first control signal to said third buffer amplifier in a first operation mode, and for selecting the serial data signal from said further parallel to serial converter and outputting the selected serial data signal to said third buffer amplifier in a second operation mode; and
a second selector for selecting the second control signal received via said second buffer amplifier and outputting the selected second control signal to said controller in the first operation mode, and for selecting the serial data signal received via said second buffer amplifier and outputting the selected serial data signal to said further serial to parallel converter in the second operation mode, and
wherein, in said first operation mode, upon receiving two types of second control signals different from each other from said other side apparatuses after transmitting the first control signal to said other side apparatus, said controller executes full-duplex data communication using said two signal terminals by being set from said first operation mode to said second operation mode, transmitting the serial data signal to said further side apparatus via said first signal terminal, receiving the serial data signal from said further side apparatus via said second signal terminal, transmitting to said first signal terminal a serial data signal indicating a notice of termination upon end of the serial data signal to be transmitted, and judging as a data communication termination upon reception of the second control signal from said further side apparatus in response to the transmission of the serial data signal.

4. The serial interface apparatus as claimed in claim 2, further comprising:
a further parallel to serial converter for converting the parallel data signal to be transmitted from said a controller, into a serial data signal;
a further serial to parallel converter for converting the received serial data signal into a parallel data signal, and outputting the parallel data signal to said controller;
a first selector for selecting the first control signal from said controller and outputting the selected first control signal to said third buffer amplifier in a first operation mode, and for selecting the serial data signal from said further parallel to serial converter and outputting the selected serial data signal to said third buffer amplifier in a second operation mode; and
a second selector for selecting the second control signal received via said second buffer amplifier and outputting the selected second control signal to said controller in the first operation mode, and for selecting the serial data signal received via said second buffer amplifier and outputting the selected serial data signal to said further serial to parallel converter in the second operation mode, and
wherein, in said first operation mode, upon receiving two types of second control signals different from each other from said other side apparatuses after transmitting the first control signal to said other side apparatus, said controller executes full-duplex data communication using said two signal terminals by being set from said first operation mode to said second operation mode, transmitting the serial data signal to said further side apparatus via said first signal terminal, receiving the serial data signal from said further side apparatus via said second signal terminal, transmitting to said first signal terminal a serial data signal indicating a notice of termination upon end of the serial data signal to be transmitted, and judging as a data communication termination upon reception of the second control signal from said further side apparatus in response to the transmission of the serial data signal.

5. A bidirectional serial interface system, comprising first and second serial interface apparatuses, each of which is a serial interface apparatus comprising:
a controller for generating a parallel data signal and a control signal, and performing communication control;
a parallel to serial converter for converting a parallel data signal to be transmitted from said controller, into a serial data signal;
a data transmitting terminal for transmitting the converted serial data signal to other side apparatus;
a data receiving terminal for receiving the serial data signal from said other side apparatus;
a serial to parallel converter for converting the received serial data signal into a parallel data signal, and outputting the parallel data signal to said controller;
a first control signal terminal for transmitting a first control signal for confirmation of transmission request from said controller to said other side apparatus; and
a second control signal terminal for receiving a second control signal indicating confirmation of possibly receiving from said other side apparatus, and outputting the received second control signal to said controller;
wherein said serial interface apparatus further comprises:
a first signal terminal for sharing said data transmitting terminal and the second control signal terminal;
a second signal terminal for sharing said data receiving terminal and the first control signal terminal;
a first buffer amplifier for buffer-amplifying the converted serial data signal, and outputting a buffer-amplified serial data signal to said first signal terminal;
a second buffer amplifier for buffer-amplifying the serial data signal received via said second signal terminal, and outputting a buffer-amplified serial data signal to said serial to parallel converter;
a third buffer amplifier for buffer-amplifying the first control signal, and outputting a buffer-amplified first control signal to said second signal terminal; and
a fourth buffer amplifier for buffer-amplifying the received second control signal via said first signal terminal, and outputting a buffer-amplified second control signal to said controller,
wherein, upon receiving two types of second control signals different from each other from said other side apparatuses after transmitting the first control signal to said other side apparatus, said controller executes half-duplex data communication using said two signal terminals by transmitting the serial data signal to said other side apparatus via said first signal terminal, transmitting to said first signal terminal a serial data signal indicating a notice of termination upon end of the serial data signal to be transmitted, and judging as a data communication termination upon reception of the second control signal from said other side apparatus in response to the transmission of the serial data signal, and
wherein the first and second serial interface apparatuses being connected and disposed so as to oppose to each other.

6. A serial communication method for use in a serial interface apparatus comprising:
a first signal terminal for sharing a data transmitting terminal for transmitting a converted serial data signal to other side apparatus which is a serial interface apparatus, and a second control signal terminal for receiving a second control signal indicating confirmation of possibly receiving from said other side apparatus and outputting the received second control signal to a controller; and
a second signal terminal for sharing a data receiving terminal for receiving the serial data signal from said other side apparatus, and a first control signal terminal for transmitting a first control signal for confirmation of transmission request from said controller to said other side apparatus,
wherein said serial communication method including the following steps of:
transmitting the first control signal to said other side apparatus;
transmitting the serial data signal to said other side apparatus via said first signal terminal upon receiving two types of second control signals different from each other from said other side apparatuses; and
transmitting to said first signal terminal a serial data signal indicating a notice of termination upon end of the serial data signal to be transmitted, and judging as a data communication termination upon reception of the second control signal from said other side apparatus responded to the transmission of the serial data signal, thereby executing half-duplex data communication using said two signal terminals.

7. The serial communication method as claimed in claim 6, further including:
transmitting the first control signal to said other side apparatus;
transmitting the serial data signal to said other side apparatus via said first signal terminal upon receiving two types of second control signals different from each other from said other side apparatuses;
receiving the serial data signal from said other side apparatus via said second signal terminal; and
transmitting to said first signal terminal a serial data signal indicating a notice of termination upon end of the serial data signal to be transmitted, and judging as a data communication termination receiving the second control signal from said other side apparatus responded to the transmission of the serial data signal, thereby executing full-duplex data communication using said two signal terminals.
